(19) United States
(12) Patent Application Publication
(10) Pub. No.: US 2025/0159258 A1
(43) Pub. Date: May 15, 2025

(54) METHOD, APPARATUS, AND MEDIUM FOR VISUAL DATA PROCESSING

(71) Applicants: Douyin Vision (Beijing) Co., Ltd., Beijing (CN); Bytedance Inc., Los Angeles, CA (US)

(72) Inventors: Semih Esenlik, Los Angeles, CA (US); Zhaobin Zhang, Los Angeles, CA (US); Yaojun Wu, Beijing (CN); Yue Li, Los Angeles, CA (US); Kai Zhang, Los Angeles, CA (US); Li Zhang, Los Angeles, CA (US)

(21) Appl. No.: 19/022,954

(22) Filed: Jan. 15, 2025

Related U.S. Application Data
(63) Continuation of application No. PCT/CN2023/107579, filed on Jul. 14, 2023.

(30) Foreign Application Priority Data
Jul. 16, 2022 (WO) PCT/CN2022/106139

(51) Int. Cl. H04N 19/625; H04N 19/124; H04N 19/63

(52) U.S. Cl. CPC H04N 19/625; H04N 19/124; H04N 19/63

(57) ABSTRACT

Embodiments of the present disclosure provide a solution for visual data processing. A method for visual data processing is proposed. The method comprises: obtaining, for a conversion between visual data and a bitstream of the visual data, region information indicating positions and sizes of a plurality of regions in a quantized latent representation of the visual data; selecting, based on the region information, a set of target neighboring samples from a plurality of candidate neighboring samples of a current sample in the quantized latent representation, the set of target neighboring samples being in the same region as the current sample; determining statistical information of the current sample based on the set of target neighboring samples; and performing the conversion based on the statistical information.

### CROSS REFERENCE TO RELATED APPLICATIONS

This application is a continuation of International Application No. PCT/CN2023/107579, filed on Jul. 14, 2023, which claims the benefit of International Application No. PCT/CN2022/106139, filed on Jul. 16, 2022. The entire contents of these applications are hereby incorporated by reference in their entireties.

### FIELDS

Embodiments of the present disclosure relates generally to visual data processing techniques, and more particularly, to neural network-based visual data coding.

### BACKGROUND

The past decade has witnessed the rapid development of deep learning in a variety of areas, especially in computer vision and image processing. Neural network was invented originally with the interdisciplinary research of neuroscience and mathematics. It has shown strong capabilities in the context of non-linear transform and classification. Neural network-based image/video compression technology has gained significant progress during the past half decade. It is reported that the latest neural network-based image compression algorithm achieves comparable rate-distortion (R-D) performance with Versatile Video Coding (VVC). With the performance of neural image compression continually being improved, neural network-based video compression has become an actively developing research area. However, coding quality and coding efficiency of neural network-based image/video coding is generally expected to be further improved.

### SUMMARY

Embodiments of the present disclosure provide a solution for visual data processing.

In a first aspect, a method for visual data processing is proposed. The method comprises: obtaining, for a conversion between visual data and a bitstream of the visual data, region information indicating positions and sizes of a plurality of regions in a quantized latent representation of the visual data; selecting, based on the region information, a set of target neighboring samples from a plurality of candidate neighboring samples of a current sample in the quantized latent representation, the set of target neighboring samples being in the same region as the current sample; determining statistical information of the current sample based on the set of target neighboring samples; and performing the conversion based on the statistical information.

According to the method in accordance with the first aspect of the present disclosure, the statistical information of a current sample in the quantized latent representation of the visual data is determined based on a set of neighboring samples in the same region as the current sample. In aid of taking the region information regarding a plurality of regions in the quantized latent representation into consideration, the proposed method can advantageously improve the coding quality, especially in a case that the latent representation of the visual data comprises regions with different statistical properties.

In a second aspect, an apparatus for visual data processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of visual data which is generated by a method performed by an apparatus for visual data processing. The method comprises: obtaining region information indicating positions and sizes of a plurality of regions in a quantized latent representation of the visual data; selecting, based on the region information, a set of target neighboring samples from a plurality of candidate neighboring samples of a current sample in the quantized latent representation, the set of target neighboring samples being in the same region as the current sample; determining statistical information of the current sample based on the set of target neighboring samples; and generating the bitstream based on the statistical information.

In a fifth aspect, a method for storing a bitstream of visual data is proposed. The method comprises: obtaining region information indicating positions and sizes of a plurality of regions in a quantized latent representation of the visual data; selecting, based on the region information, a set of target neighboring samples from a plurality of candidate neighboring samples of a current sample in the quantized latent representation, the set of target neighboring samples being in the same region as the current sample; determining statistical information of the current sample based on the set of target neighboring samples; generating the bitstream based on the statistical information; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example visual data coding system, in accordance with some embodiments of the present disclosure;

FIG. 2 illustrates a typical transform coding scheme;

FIG. 3 illustrates an image from the Kodak dataset and different representations of the image;

FIG. 4 illustrates a network architecture of an autoencoder implementing the hyperprior model;

FIG. 5 illustrates a block diagram of a combined model;

FIG. 6 illustrates an encoding process of the combined model;

FIG. 7 illustrates a decoding process of the combined model;

FIG. 8 illustrates an example coding process with wavelet-based transform;

FIG. 9 illustrates an example output of a forward wavelet-based transform;

FIG. 10 illustrates partitioning of the output of a forward wavelet-based transform;

FIG. 11 illustrates a kernel of an autoregressive model;

FIG. 12A illustrates another kernel of an autoregressive model;

FIG. 12B illustrates a further kernel of an autoregressive model;

FIG. 13 illustrates a latent representation with multiple regions with different statistical properties;

FIG. 14A illustrates an example region map in accordance with some embodiments of the present disclosure;

FIG. 14B illustrates a wavelet-based transform output corresponding the region map shown in FIG. 14A;

FIG. 15 illustrates another example region map in accordance with some embodiments of the present disclosure;

FIG. 16 illustrates a further example region map in accordance with some embodiments of the present disclosure;

FIG. 17A illustrates an example of group division of different regions in accordance with some embodiments of the present disclosure;

FIG. 17B illustrates another example of group division of different regions in accordance with some embodiments of the present disclosure;

FIG. 18 illustrates an example of the utilization of the reference in accordance with some embodiments of the present disclosure;

FIG. 19 illustrates a flowchart of a method for visual data processing in accordance with embodiments of the present disclosure;

FIG. 20 illustrates an example of visual data processing in accordance with some embodiments of the present disclosure; and

FIG. 21 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

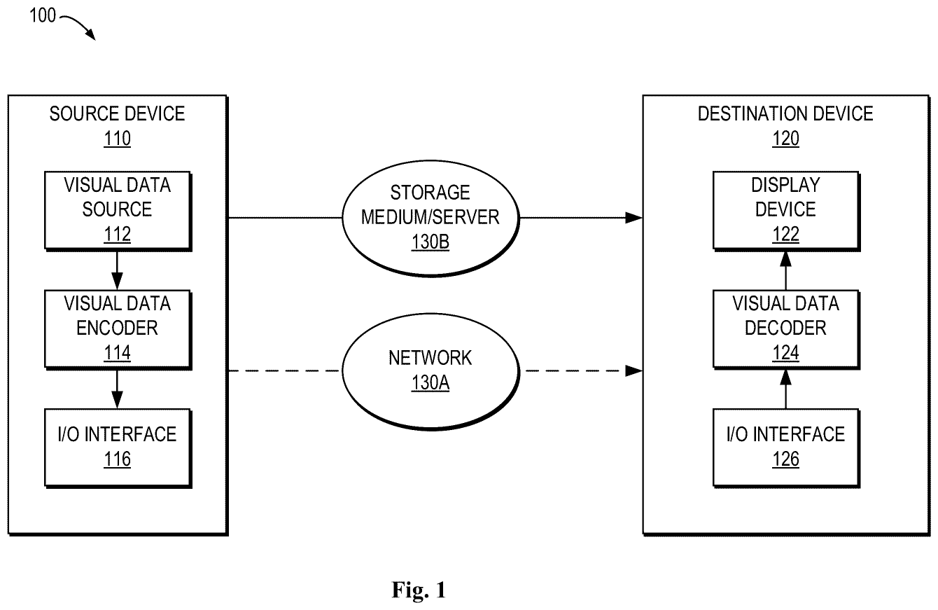

FIG. 1 is a block diagram that illustrates an example visual data coding system 100 that may utilize the techniques of this disclosure. As shown, the visual data coding system 100 may include a source device 110 and a destination device 120. The source device 110 can be also referred to as a visual data encoding device, and the destination device 120 can be also referred to as a visual data decoding device. In operation, the source device 110 can be configured to generate encoded visual data and the destination device 120 can be configured to decode the encoded visual data generated by the source device 110. The source device 110 may include a visual data source 112, a visual data encoder 114, and an input/output (I/O) interface 116.

The visual data source 112 may include a source such as a visual data capture device. Examples of the visual data capture device include, but are not limited to, an interface to receive visual data from a visual data provider, a computer graphics system for generating visual data, and/or a combination thereof.

The visual data may comprise one or more pictures of a video or one or more images. The visual data encoder 114 encodes the visual data from the visual data source 112 to generate a bitstream. The bitstream may include a sequence of bits that form a coded representation of the visual data. The bitstream may include coded pictures and associated visual data. The coded picture is a coded representation of a picture. The associated visual data may include sequence parameter sets, picture parameter sets, and other syntax structures. The I/O interface 116 may include a modulator/demodulator and/or a transmitter. The encoded visual data may be transmitted directly to destination device 120 via the I/O interface 116 through the network 130A. The encoded visual data may also be stored onto a storage medium/server 130B for access by destination device 120.

The destination device 120 may include an I/O interface 126, a visual data decoder 124, and a display device 122. The I/O interface 126 may include a receiver and/or a modem. The I/O interface 126 may acquire encoded visual data from the source device 110 or the storage medium/server 130B. The visual data decoder 124 may decode the encoded visual data. The display device 122 may display the decoded visual data to a user. The display device 122 may be integrated with the destination device 120, or may be external to the destination device 120 which is configured to interface with an external display device.

The visual data encoder 114 and the visual data decoder 124 may operate according to a visual data coding standard, such as video coding standard or still picture coding standard and other current and/or further standards.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific visual data codecs, the disclosed techniques are applicable to other coding technologies also. Furthermore, while some embodiments describe coding steps in detail, it will be understood that corresponding steps decoding that undo the coding will be implemented by a decoder. Furthermore, the term visual data processing encompasses visual data coding or compression, visual data decoding or decompression and visual data transcoding in which visual data are represented from one compressed format into another compressed format or at a different compressed bitrate.

### 1. Brief Summary

A neural network-based image and video compression method is proposed, wherein an autoregressive neural network is utilized. The disclosure targets the problem of sample regions with different statistical properties, therefore increasing the efficiency of the prediction in the latent domain. The disclosure additionally improves the speed of prediction by allowing parallel processing.

### 2. Introduction

The past decade has witnessed the rapid development of deep learning in a variety of areas, especially in computer vision and image processing. Inspired from the great success of deep learning technology to computer vision areas, many researchers have shifted their attention from conventional image/video compression techniques to neural image/video compression technologies. Neural network was invented originally with the interdisciplinary research of neuroscience and mathematics. It has shown strong capabilities in the context of non-linear transform and classification. Neural network-based image/video compression technology has gained significant progress during the past half decade. It is reported that the latest neural network-based image compression algorithm achieves comparable R-D performance with Versatile Video Coding (VVC), the latest video coding standard developed by Joint Video Experts Team (JVET) with experts from MPEG and VCEG. With the performance of neural image compression continually being improved, neural network-based video compression has become an actively developing research area. However, neural network-based video coding still remains in its infancy due to the inherent difficulty of the problem.

### 2.1. Image/Video Compression

Image/video compression usually refers to the computing technology that compresses image/video into binary code to facilitate storage and transmission. The binary codes may or may not support losslessly reconstructing the original image/video, termed lossless compression and lossy compression. Most of the efforts are devoted to lossy compression since lossless reconstruction is not necessary in most scenarios. Usually the performance of image/video compression algorithms is evaluated from two aspects, i.e. compression ratio and reconstruction quality. Compression ratio is directly related to the number of binary codes, the less the better; Reconstruction quality is measured by comparing the reconstructed image/video with the original image/video, the higher the better.

Image/video compression techniques can be divided into two branches, the classical video coding methods and the neural-network-based video compression methods. Classical video coding schemes adopt transform-based solutions, in which researchers have exploited statistical dependency in the latent variables (e.g., DCT or wavelet coefficients) by carefully hand-engineering entropy codes modeling the dependencies in the quantized regime. Neural network-based video compression is in two flavors, neural network-based coding tools and end-to-end neural network-based video compression. The former is embedded into existing classical video codecs as coding tools and only serves as part of the framework, while the latter is a separate framework developed based on neural networks without depending on classical video codecs.

In the last three decades, a series of classical video coding standards have been developed to accommodate the increasing visual content. The international standardization organizations ISO/IEC has two expert groups namely Joint Photographic Experts Group (JPEG) and Moving Picture Experts Group (MPEG), and ITU-T also has its own Video Coding Experts Group (VCEG) which is for standardization of image/video coding technology. The influential video coding standards published by these organizations include JPEG, JPEG 2000, H.262, H.264/AVC and H.265/HEVC. After H.265/HEVC, the Joint Video Experts Team (JVET) formed by MPEG and VCEG has been working on a new video coding standard Versatile Video Coding (VVC). The first version of VVC was released in July 2020. An average of 50% bitrate reduction is reported by VVC under the same visual quality compared with HEVC.

Neural network-based image/video compression is not a new invention since there were a number of researchers working on neural network-based image coding. But the network architectures were relatively shallow, and the performance was not satisfactory. Benefit from the abundance of data and the support of powerful computing resources, neural network-based methods are better exploited in a variety of applications. At present, neural network-based image/video compression has shown promising improvements, confirmed its feasibility. Nevertheless, this technology is still far from mature and a lot of challenges need to be addressed.

### 2.2. Neural Networks

Neural networks, also known as artificial neural networks (ANN), are the computational models used in machine learning technology which are usually composed of multiple processing layers and each layer is composed of multiple simple but non-linear basic computational units. One benefit of such deep networks is believed to be the capacity for processing data with multiple levels of abstraction and converting data into different kinds of representations. Note that these representations are not manually designed; instead, the deep network including the processing layers is learned from massive data using a general machine learning procedure. Deep learning eliminates the necessity of handcrafted representations, and thus is regarded useful especially for processing natively unstructured data, such as acoustic and visual signal, whilst processing such data has been a longstanding difficulty in the artificial intelligence field.

### 2.3. Neural Networks for Image Compression

Existing neural networks for image compression methods can be classified in two categories, i.e., pixel probability modeling and auto-encoder. The former one belongs to the predictive coding strategy, while the latter one is the transform-based solution. Sometimes, these two methods are combined together in literature.

### 2.3.1. Pixel Probability Modeling

According to Shannon's information theory, the optimal method for lossless coding can reach the minimal coding rate −log₂ p(x) where p(x) is the probability of symbol x. A number of lossless coding methods were developed in literature and among them arithmetic coding is believed to be among the optimal ones. Given a probability distribution p(x), arithmetic coding ensures that the coding rate to be as close as possible to its theoretical limit−log₂ p(x) without considering the rounding error. Therefore, the remaining problem is to how to determine the probability, which is however very challenging for natural image/video due to the curse of dimensionality. Following the predictive coding strategy, one way to model p(x) is to predict pixel probabilities one by one in a raster scan order based on previous observations, where x is an image.

$$p ( x ) = p ( {x}_{1} ) p ( {x}_{2} \vert {x}_{1} ) … p ( {x}_{i} \vert {x}_{1} , … , {x}_{i - 1} ) … p ( {x}_{m \times n} \vert {x}_{1} , … , {x}_{m \times n - 1} ) \qquad ( 1 )$$

where m and n are the height and width of the image, respectively. The previous observation is also known as the context of the current pixel. When the image is large, it can be difficult to estimate the conditional probability, thereby a simplified method is to limit the range of its context.

$$p ( x ) = p ( {x}_{1} ) p ( {x}_{2} \vert {x}_{1} ) … p ( {x}_{i} \vert {x}_{i - k} , … , {x}_{i - 1} ) … p ( {x}_{m \times n} \vert {x}_{m \times n - k} , … , {x}_{m \times n - 1} ) \qquad ( 2 )$$

where k is a pre-defined constant controlling the range of the context.

It should be noted that the condition may also take the sample values of other color components into consideration. For example, when coding the RGB color component, R sample is dependent on previously coded pixels (including RIG/B samples), the current G sample may be coded according to previously coded pixels and the current R sample, while for coding the current B sample, the previously coded pixels and the current R and G samples may also be taken into consideration.

Neural networks were originally introduced for computer vision tasks and have been proven to be effective in regression and classification problems. Therefore, it has been proposed using neural networks to estimate the probability of p(x₁) given its context x₁, x₂, . . . , xᵢ₋₁. In an existing design, the pixel probability is proposed for binary images, i.e., xᵢ ∈{−1, +1}. The neural autoregressive distribution estimator (NADE) is designed for pixel probability modeling, where is a feed-forward network with a single hidden layer. A similar work is presented in an existing design, where the feed-forward network also has connections skipping the hidden layer, and the parameters are also shared. Experiments are performed on the binarized MNIST dataset. In an existing design, NADE is extended to a real-valued model RNADE, where the probability p(xᵢ|x₁, . . . , xᵢ₋₁) is derived with a mixture of Gaussians. Their feed-forward network also has a single hidden layer, but the hidden layer is with rescaling to avoid saturation and uses rectified linear unit (ReLU) instead of sigmoid. In an existing design, NADE and RNADE are improved by using reorganizing the order of the pixels and with deeper neural networks.

Designing advanced neural networks plays an important role in improving pixel probability modeling. In an existing design, multi-dimensional long short-term memory (LSTM) is proposed, which is working together with mixtures of conditional Gaussian scale mixtures for probability modeling. LSTM is a special kind of recurrent neural networks (RNNs) and is proven to be good at modeling sequential data. The spatial variant of LSTM is used for images later in an existing design. Several different neural networks are studied, including RNNs and CNNs namely PixelRNN and PixelCNN, respectively. In PixelRNN, two variants of LSTM, called row LSTM and diagonal BiLSTM are proposed, where the latter is specifically designed for images. PixelRNN incorporates residual connections to help train deep neural networks with up to 12 layers. In PixelCNN, masked convolutions are used to suit for the shape of the context. Comparing with previous works, PixelRNN and PixelCNN are more dedicated to natural images: they consider pixels as discrete values (e.g., 0, 1, . . . , 255) and predict a multinomial distribution over the discrete values; they deal with color images in RGB color space; they work well on large-scale image dataset ImageNet. In an existing design, Gated PixelCNN is proposed to improve the PixelCNN, and achieves comparable performance with PixelRNN but with much less complexity. In an existing design, PixelCNN++ is proposed with the following improvements upon PixelCNN: a discretized logistic mixture likelihood is used rather than a 256-way multinomial distribution; down-sampling is used to capture structures at multiple resolutions; additional short-cut connections are introduced to speed up training; dropout is adopted for regularization; RGB is combined for one pixel. In an existing design, PixelSNAIL is proposed, in which casual convolutions are combined with self-attention.

Most of the above methods directly model the probability distribution in the pixel domain. Some researchers also attempt to model the probability distribution as a conditional one upon explicit or latent representations. That being said, it may be estimated that:

$$p ( x \vert h ) = {\prod }_{i = 1}^{m \times n} p ( {x}_{i} \vert {x}_{1} , … , {x}_{i - 1} , h ) \qquad ( 3 )$$

where h is the additional condition and p(x)=p(h)p(x|h), meaning the modeling is split into an unconditional one and a conditional one. The additional condition can be image label information or high-level representations.

### 2.3.2. Auto-Encoder

Auto-encoder originates from the well-known work proposed by Hinton and Salakhutdinov. The method is trained for dimensionality reduction and consists of two parts: encoding and decoding. The encoding part converts the high-dimension input signal to low-dimension representations, typically with reduced spatial size but a greater number of channels. The decoding part attempts to recover the high-dimension input from the low-dimension representation. Auto-encoder enables automated learning of representations and eliminates the need of hand-crafted features, which is also believed to be one of the most important advantages of neural networks.

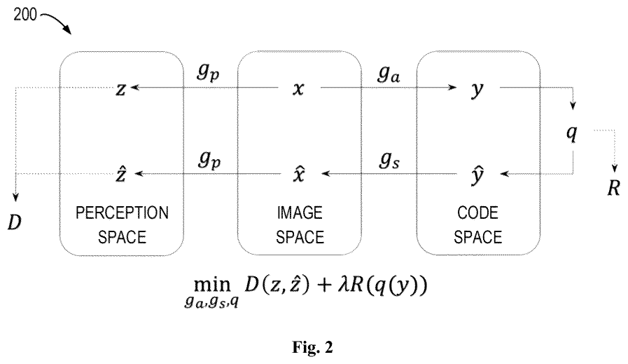

FIG. 2 illustrates a typical transform coding scheme. The original image x is transformed by the analysis network gₐ to achieve the latent representation y. The latent representation y is quantized and compressed into bits. The number of bits R is used to measure the coding rate. The quantized latent representation ŷ is then inversely transformed by a synthesis network gₛ to obtain the reconstructed image R. The distortion is calculated in a perceptual space by transforming x and \hat{x} with the function gₚ.

It is intuitive to apply auto-encoder network to lossy image compression. It only needs to encode the learned latent representation from the well-trained neural networks. However, it is not trivial to adapt auto-encoder to image compression since the original auto-encoder is not optimized for compression thereby not efficient by directly using a trained auto-encoder. In addition, there exist other major challenges: First, the low-dimension representation should be quantized before being encoded, but the quantization is not differentiable, which is required in backpropagation while training the neural networks. Second, the objective under compression scenario is different since both the distortion and the rate need to be take into consideration. Estimating the rate is challenging. Third, a practical image coding scheme needs to support variable rate, scalability, encoding/decoding speed, interoperability. In response to these challenges, a number of researchers have been actively contributing to this area.

The prototype auto-encoder for image compression is in FIG. 2, which can be regarded as a transform coding strategy. The original image x is transformed with the analysis network y=gₐ (x), where y is the latent representation which will be quantized and coded. The synthesis network will inversely transform the quantized latent representation ŷ back to obtain the reconstructed image \hat{x}=gₛ(ŷ). The framework is trained with the rate-distortion loss function, i.e., [symbol] =D+λR, where D is the distortion between x and \hat{x}, R is the rate calculated or estimated from the quantized representation ŷ, and λ is the Lagrange multiplier. It should be noted that D can be calculated in either pixel domain or perceptual domain. All existing research works follow this prototype and the difference might only be the network structure or loss function.

In terms of network structure, RNNs and CNNs are the most widely used architectures. In the RNNs relevant category, Toderici et al. propose a general framework for variable rate image compression using RNN. They use binary quantization to generate codes and do not consider rate during training. The framework indeed provides a scalable coding functionality, where RNN with convolutional and deconvolution layers is reported to perform decently. Toderici et al. then proposed an improved version by upgrading the encoder with a neural network similar to PixelRNN to compress the binary codes. The performance is reportedly better than JPEG on Kodak image dataset using MS-SSIM evaluation metric. Johnston et al. further improve the RNN-based solution by introducing hidden-state priming. In addition, an SSIM-weighted loss function is also designed, and spatially adaptive bitrates mechanism is enabled. They achieve better results than BPG on Kodak image dataset using MS-SSIM as evaluation metric. Covell et al. support spatially adaptive bitrates by training stop-code tolerant RNNs.

Ballé et al. proposes a general framework for rate-distortion optimized image compression. The use multiary quantization to generate integer codes and consider the rate during training, i.e. the loss is the joint rate-distortion cost, which can be MSE or others. They add random uniform noise to stimulate the quantization during training and use the differential entropy of the noisy codes as a proxy for the rate. They use generalized divisive normalization (GDN) as the network structure, which consists of a linear mapping followed by a nonlinear parametric normalization. The effectiveness of GDN on image coding is verified in an existing design. Ballé et al. then propose an improved version, where they use 3 convolutional layers each followed by a down-sampling layer and a GDN layer as the forward transform. Accordingly, they use 3 layers of inverse GDN each followed by an up-sampling layer and convolution layer to stimulate the inverse transform. In addition, an arithmetic coding method is devised to compress the integer codes. The performance is reportedly better than JPEG and JPEG 2000 on Kodak dataset in terms of MSE. Furthermore, Ballé et al. improve the method by devising a scale hyper-prior into the auto-encoder. They transform the latent representation y with a subnet hₐ to z=hₐ(y) and z will be quantized and transmitted as side information. Accordingly, the inverse transform is implemented with a subnet hₛ attempting to decode from the quantized side information \hat{z} to the standard deviation of the quantized ŷ, which will be further used during the arithmetic coding of ŷ. On the Kodak image set, their method is slightly worse than BPG in terms of PSNR. D. Minnen et al. further exploit the structures in the residue space by introducing an autoregressive model to estimate both the standard deviation and the mean. In an existing design, Z. Cheng et al. use Gaussian mixture model to further remove redundancy in the residue. The reported performance is on par with VVC on the Kodak image set using PSNR as evaluation metric.

### 2.3.3. Hyper Prior Model

In the transform coding approach to image compression, the encoder subnetwork (section 2.3.2) transforms the image vector x using a parametric analysis transform gₐ(x, Ø_{g}) into a latent representation y, which is then quantized to form ŷ. Because ŷ is discrete-valued, it can be losslessly compressed using entropy coding techniques such as arithmetic coding and transmitted as a sequence of bits.

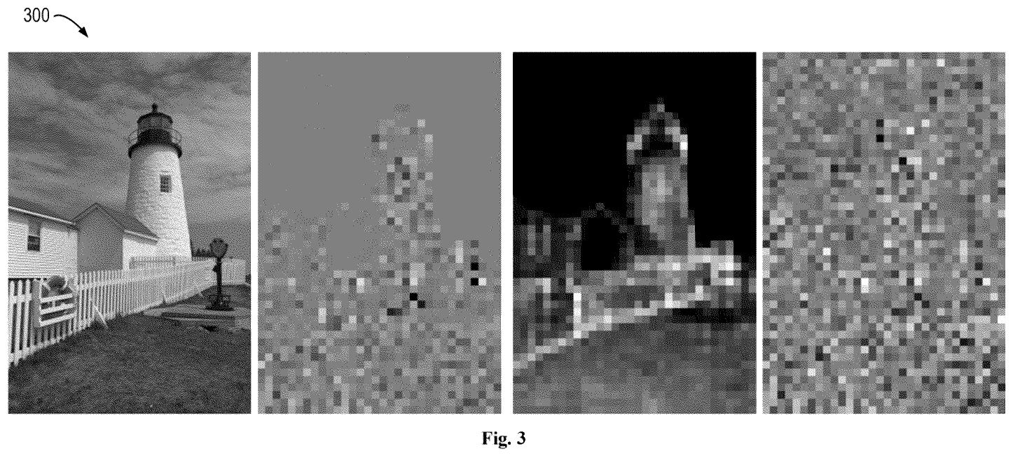

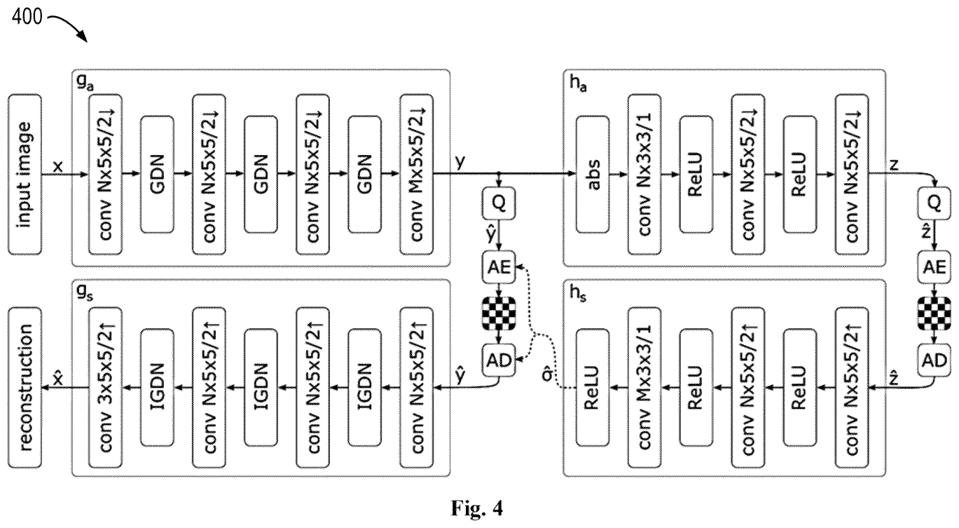

As evident from the middle left and middle right image of FIG. 3, there are significant spatial dependencies among the elements of ŷ. Notably, their scales (middle right image) appear to be coupled spatially. In an existing design, an additional set of random variables \hat{z} are introduced to capture the spatial dependencies and to further reduce the redundancies. In this case the image compression network is depicted in FIG. 4.

In FIG. 4, the left hand of the models is the encoder gₐ and decoder gₛ (explained in section 2.3.2). The right-hand side is the additional hyper encoder hₐ and hyper decoder hₛ networks that are used to obtain \hat{z}. In this architecture the encoder subjects the input image x to gₐ, yielding the responses y with spatially varying standard deviations. The responses y are fed into hₐ, summarizing the distribution of standard deviations in z. z is then quantized (\hat{z}), compressed, and transmitted as side information. The encoder then uses the quantized vector \hat{z} to estimate σ, the spatial distribution of standard deviations, and uses it to compress and transmit the quantized image representation ŷ. The decoder first recovers \hat{z} from the compressed signal. It then uses hₛ to obtain σ, which provides it with the correct probability estimates to successfully recovery ŷ as well. It then feeds ŷ into gₛ to obtain the reconstructed image.

When the hyper encoder and hyper decoder are added to the image compression network, the spatial redundancies of the quantized latent y are reduced. The rightmost image in FIG. 3 correspond to the quantized latent when hyper encoder/decoder are used. Compared to middle right image, the spatial redundancies are significantly reduced, as the samples of the quantized latent are less correlated.

FIG. 3 illustrates an image from the Kodak dataset and different representations of the image. The leftmost image in FIG. 3 shows an image from the Kodak dataset. The middle left image in FIG. 3 shows visualization of a latent representation y of that image. The middle right image in FIG. 3 shows standard deviations σ of the latent. The rightmost image in FIG. 3 shows latents y after the hyper prior (hyper encoder and decoder) network is introduced. FIG. 4 illustrates a network architecture of an autoencoder implementing the hyperprior model. The left side shows an image autoencoder network, the right side corresponds to the hyperprior subnetwork. The analysis and synthesis transforms are denoted as gₐ and gₐ. Q represents quantization, and AE, AD represent arithmetic encoder and arithmetic decoder, respectively. The hyperprior model consists of two subnetworks, hyper encoder (denoted with hₐ) and hyper decoder (denoted with hₛ). The hyper prior model generates a quantized hyper latent (\hat{z}) which comprises information about the probability distribution of the samples of the quantized latent ŷ. \hat{z} is included in the bitsteam and transmitted to the receiver (decoder) along with ŷ.

### 2.3.4. Context Model

Although the hyperprior model improves the modelling of the probability distribution of the quantized latent ŷ, additional improvement can be obtained by utilizing an autoregressive model that predicts quantized latents from their causal context (Context Model).

The term auto-regressive means that the output of a process is later used as input to it. For example the context model subnetwork generates one sample of a latent, which is later used as input to obtain the next sample.

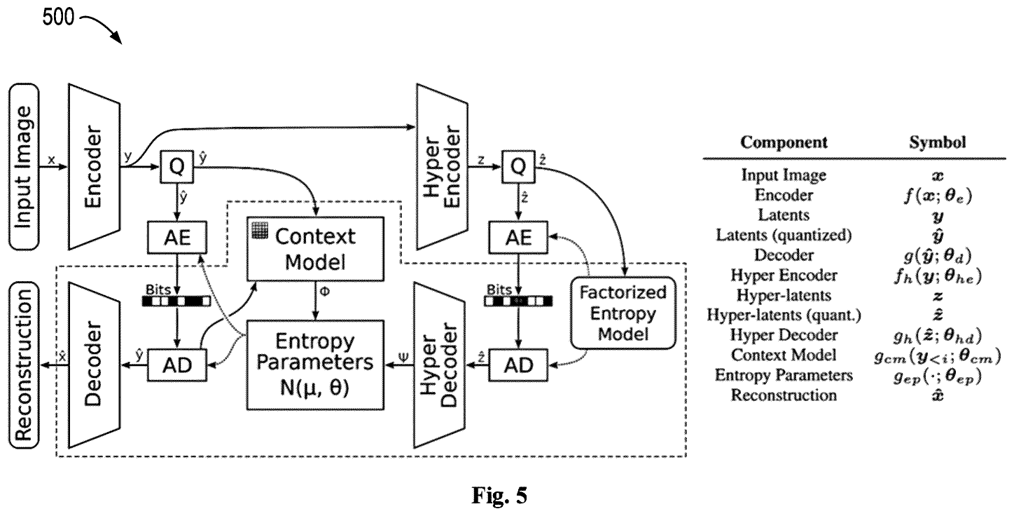

In an existing design, a joint architecture is utilized where both hyperprior model subnetwork (hyper encoder and hyper decoder) and a context model subnetwork are utilized. The hyperprior and the context model are combined to learn a probabilistic model over quantized latents ŷ, which is then used for entropy coding. As depicted in FIG. 5, the outputs of context subnetwork and hyper decoder subnetwork are combined by the subnetwork called Entropy Parameters, which generates the mean μ and scale (or variance) σ parameters for a Gaussian probability model. The gaussian probability model is then used to encode the samples of the quantized latents into bitstream with the help of the arithmetic encoder (AE) module. In the decoder the gaussian probability model is utilized to obtain the quantized latents ŷ from the bitstream by arithmetic decoder (AD) module.

FIG. 5 illustrates a block diagram of a combined model. The combined model jointly optimizes an autoregressive component that estimates the probability distributions of latents from their causal context (Context Model) along with a hyperprior and the underlying autoencoder. Real-valued latent representations are quantized (Q) to create quantized latents (ŷ) and quantized hyper-latents (\hat{z}), which are compressed into a bitstream using an arithmetic encoder (AE) and decompressed by an arithmetic decoder (AD). The highlighted region corresponds to the components that are executed by the receiver (i.e. a decoder) to recover an image from a compressed bitstream.

Typically, the latent samples are modeled as gaussian distribution or gaussian mixture models (not limited to). In an existing design and according to the FIG. 5, the context model and hyper prior are jointly used to estimate the probability distribution of the latent samples. Since a gaussian distribution can be defined by a mean and a variance (aka sigma or scale), the joint model is used to estimate the mean and variance (denoted as μ and σ).

### 2.3.5. The Encoding Process Using Joint Auto-Regressive Hyper Prior Model

FIG. 5 corresponds to the state of the art compression method that is proposed in an existing design. In this section and the next, the encoding and decoding processes will be described separately.

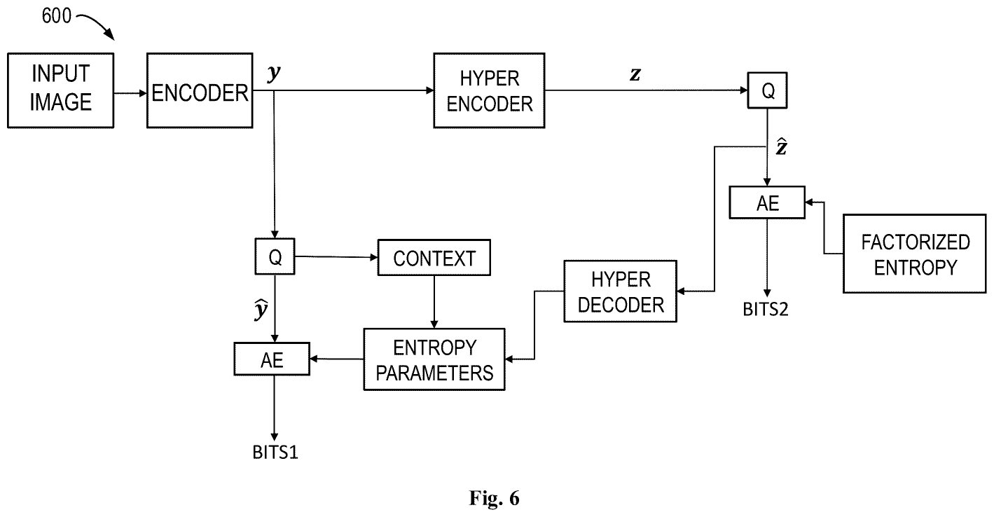

FIG. 6 depicts the encoding process. The input image is first processed with an encoder subnetwork. The encoder transforms the input image into a transformed representation called latent, denoted by y. y is then input to a quantizer block, denoted by Q, to obtained the quantized latent (ŷ). ŷ is then converted to a bitstream (bits1) using an arithmetic encoding module (denoted AE). The arithmetic encoding block converts each sample of the ŷ into a bitstream (bits1) one by one, in a sequential order.

The modules hyper encoder, context, hyper decoder, and entropy parameters subnetworks are used to estimate the probability distributions of the samples of the quantized latent ŷ. The latent y is input to hyper encoder, which outputs the hyper latent (denoted by z). The hyper latent is then quantized (\hat{z}) and a second bitstream (bits2) is generated using arithmetic encoding (AE) module. The factorized entropy module generates the probability distribution, that is used to encode the quantized hyper latent into bitstream. The quantized hyper latent includes information about the probability distribution of the quantized latent (ŷ).

The Entropy Parameters subnetwork generates the probability distribution estimations, that are used to encode the quantized latent ŷ. The information that is generated by the Entropy Parameters typically include a mean μ and scale (or variance) σ parameters, that are together used to obtain a gaussian probability distribution. A gaussian distribution of a random variable x is defined as

$$f ( x ) = \frac{1}{σ \sqrt{2 π}} {e}^{- \frac{1}{2} {( \frac{x - μ}{σ} )}^{2}}$$

wherein the parameter μ is the mean or expectation of the distribution (and also its median and mode), while the parameter μ is its standard deviation (or variance, or scale). In order to define a gaussian distribution, the mean and the variance need to be determined. In an existing design, the entropy parameters module are used to estimate the mean and the variance values.

The subnetwork hyper decoder generates part of the information that is used by the entropy parameters subnetwork, the other part of the information is generated by the autoregressive module called context module. The context module generates information about the probability distribution of a sample of the quantized latent, using the samples that are already encoded by the arithmetic encoding (AE) module. The quantized latent ŷ is typically a matrix composed of many samples. The samples can be indicated using indices, such as ŷ[i,j,k] or ŷ[i,j] depending on the dimensions of the matrix ŷ. The samples ŷ [i,j] are encoded by AE one by one, typically using a raster scan order. In a raster scan order the rows of a matrix are processed from top to bottom, wherein the samples in a row are processed from left to right. In such a scenario (wherein the raster scan order is used by the AE to encode the samples into bitstream), the context module generates the information pertaining to a sample ŷ[i,j], using the samples encoded before, in raster scan order. The information generated by the context module and the hyper decoder are combined by the entropy parameters module to generate the probability distributions that are used to encode the quantized latent ŷ into bitstream (bits1).

Finally the first and the second bitstream are transmitted to the decoder as result of the encoding process.

It is noted that the other names can be used for the modules described above. In the above description, the all of the elements in FIG. 6 are collectively called encoder. The analysis transform that converts the input image into latent representation is also called an encoder (or auto-encoder).

### 2.3.6. The Decoding Process Using Joint Auto-Regressive Hyper Prior Model

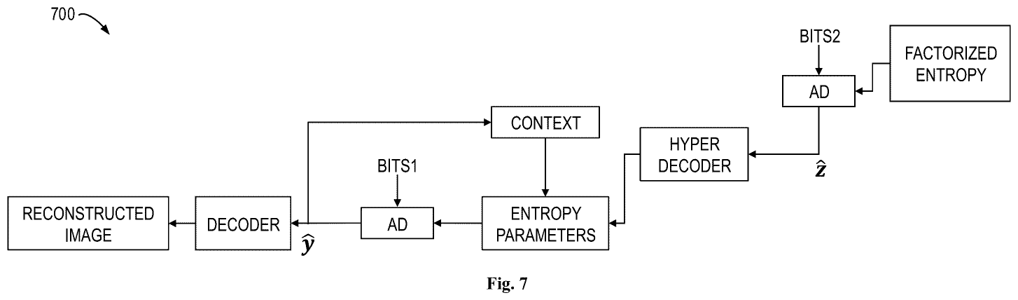

The FIG. 7 depicts the decoding process separately. In the decoding process, the decoder first receives the first bitstream (bits1) and the second bitstream (bits2) that are generated by a corresponding encoder. The bits2 is first decoded by the arithmetic decoding (AD) module by utilizing the probability distributions generated by the factorized entropy subnetwork. The factorized entropy module typically generates the probability distributions using a predetermined template, for example using predetermined mean and variance values in the case of gaussian distribution. The output of the arithmetic decoding process of the bits2 is \hat{z}, which is the quantized hyper latent. The AD process reverts to AE process that was applied in the encoder. The processes of AE and AD are lossless, meaning that the quantized hyper latent \hat{z} that was generated by the encoder can be reconstructed at the decoder without any change.

After obtaining of \hat{z}, it is processed by the hyper decoder, whose output is fed to entropy parameters module. The three subnetworks, context, hyper decoder and entropy parameters that are employed in the decoder are identical to the ones in the encoder. Therefore the exact same probability distributions can be obtained in the decoder (as in encoder), which is essential for reconstructing the quantized latent ŷ without any loss. As a result the identical version of the quantized latent ŷ that was obtained in the encoder can be obtained in the decoder.

After the probability distributions (e.g. the mean and variance parameters) are obtained by the entropy parameters subnetwork, the arithmetic decoding module decodes the samples of the quantized latent one by one from the bitstream bits1. From a practical standpoint, autoregressive model (the context model) is inherently serial, and therefore can not be sped up using techniques such as parallelization.

Finally the fully reconstructed quantized latent y is input to the synthesis transform (denoted as decoder in FIG. 7) module to obtain the reconstructed image.

In the above description, the all of the elements in FIG. 7 are collectively called decoder. The synthesis transform that converts the quantized latent into reconstructed image is also called a decoder (or auto-decoder).

### 2.3.7. Wavelet Based Neural Compression Architecture

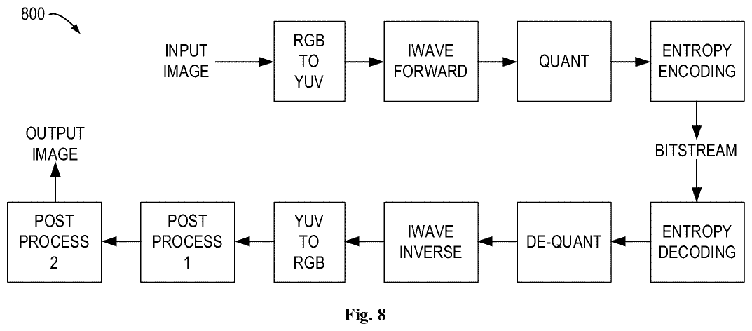

The analysis transform (denoted as encoder) in FIG. 6 and the synthesis transform (denoted as decoder) in FIG. 7 might be replaced by a wavelet based transform. FIG. 8 shows an example such an implementation. In FIG. 8, first the input image is converted from an RGB color format to a YUV color format. This conversion process is optional, and can be missing in other implementations. If however such a conversion is applied at the input image, a back conversion (from YUV to RGB) is also applied before the output image is generated. Moreover there are 2 additional post processing modules (post-process 1 and 2) shown in FIG. 8. These modules are also optional, hence might be missing in other implementations. The core of an encoder with wavelet-based transform is composed of a wavelet-based forward transform, a quantization module and an entropy coding module. After these 3 modules are applied to the input image, the bitstream is generated. The core of the decoding process is composed of entropy decoding, de-quantization process and an inverse wavelet-based transform operation. The decoding process convers the bitstream into output image. The encoding and decoding processes are depicted in FIG. 8.

After the wavelet-based forward transform is applied to the input image, in the output of the wavelet-based forward transform the image is split into its frequency components. The output of a 2-dimensional forward wavelet transform (depicted as iWave forward module in FIG. 8) might take the form depicted in FIG. 9. The input of the transform is an image of a castle. In the example, after the transform an output with 7 distinct regions are obtained. The number of distinct regions depend on the specific implementation of the transform and might different from 7. Potential number of regions are 4, 7, 10, 13 . . . .

In FIG. 9, it is seen that the input image is transformed into 7 regions with 3 small images and 4 even smaller images. The transformation is based on the frequency components, the small image at the bottom right quarter comprises the high frequency components in both horizontal and vertical directions. The smallest image at the top-left corner on the other hand comprises the lowest frequency components both in the vertical and horizontal directions. The small image on the top-right quarter comprises the high frequency components in the horizontal direction and low frequency components in the vertical direction.

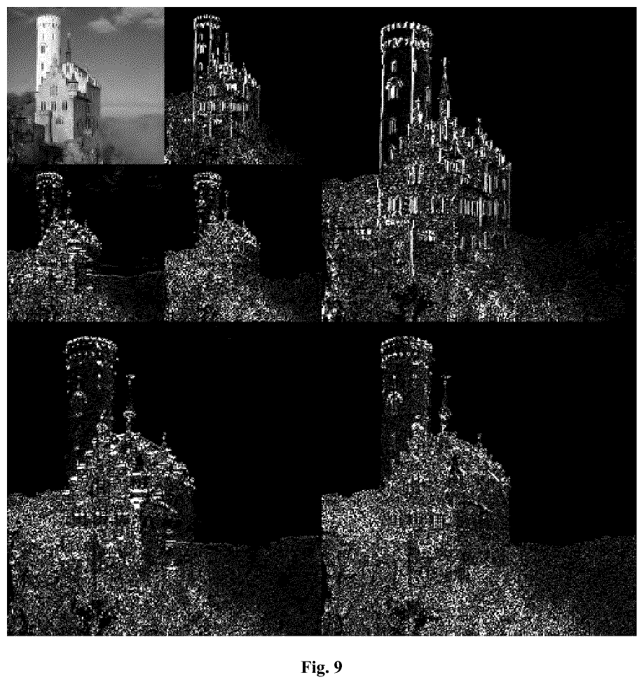

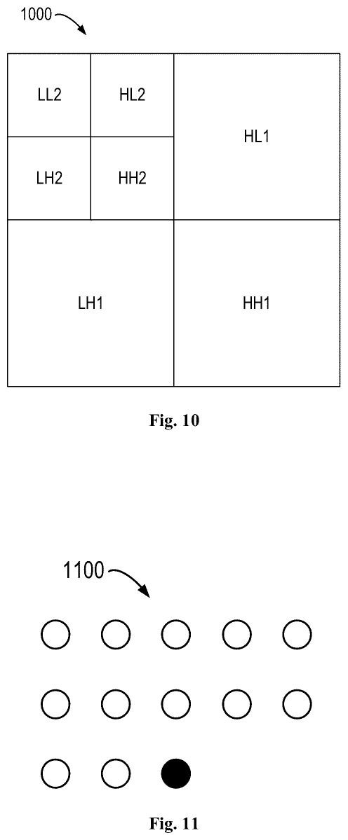

FIG. 10 depicts a possible splitting of the latent representation after the 2D forward transform. The latent representation are the samples (latent samples, or quantized latent samples) that are obtained after the 2D forward transform. The latent samples are divided into 7 sections above, denoted as HH1, LH1, HL1, LL2, HL2, LH2 and HH2. The HH1 describes that the section comprises high frequency components in the vertical direction, high frequency components in the horizontal direction and that the splitting depth is 1. HL2 describes that the section comprises low frequency components in the vertical direction, high frequency components in the horizontal direction and that the splitting depth is 2.

After the latent samples are obtained at the encoder by the forward wavelet transform, they are transmitted to the decoder by using entropy coding. At the decoder, entropy decoding is applied to obtain the latent samples, which are then inverse transformed (by using iWave inverse module in FIG. 8) to obtain the reconstructed image.

### 2.4. Neural Networks for Video Compression

Similar to conventional video coding technologies, neural image compression serves as the foundation of intra compression in neural network-based video compression, thus development of neural network-based video compression technology comes later than neural network-based image compression but needs far more efforts to solve the challenges due to its complexity. Starting from 2017, a few researchers have been working on neural network-based video compression schemes. Compared with image compression, video compression needs efficient methods to remove inter-picture redundancy. Inter-picture prediction is then a crucial step in these works. Motion estimation and compensation is widely adopted but is not implemented by trained neural networks until recently.

Studies on neural network-based video compression can be divided into two categories according to the targeted scenarios: random access and the low-latency. In random access case, it requires the decoding can be started from any point of the sequence, typically divides the entire sequence into multiple individual segments and each segment can be decoded independently. In low-latency case, it aims at reducing decoding time thereby usually merely temporally previous frames can be used as reference frames to decode subsequent frames.

### 2.4.1. Low-Latency

Chen et al. are the first to propose a video compression scheme with trained neural networks. They first split the video sequence frames into blocks and each block will choose one from two available modes, either intra coding or inter coding. If intra coding is selected, there is an associated auto-encoder to compress the block. If inter coding is selected, motion estimation and compensation are performed with tradition methods and a trained neural network will be used for residue compression. The outputs of auto-encoders are directly quantized and coded by the Huffman method.

Chen et al. propose another neural network-based video coding scheme with PixelMotionCNN. The frames are compressed in the temporal order, and each frame is split into blocks which are compressed in the raster scan order. Each frame will firstly be extrapolated with the preceding two reconstructed frames. When a block is to be compressed, the extrapolated frame along with the context of the current block are fed into the PixelMotionCNN to derive a latent representation. Then the residues are compressed by the variable rate image scheme. This scheme performs on par with H.264.

Lu et al. propose the real-sense end-to-end neural network-based video compression framework, in which all the modules are implemented with neural networks. The scheme accepts current frame and the prior reconstructed frame as inputs and optical flow will be derived with a pre-trained neural network as the motion information. The motion information will be warped with the reference frame followed by a neural network generating the motion compensated frame. The residues and the motion information are compressed with two separate neural auto-encoders. The whole framework is trained with a single rate-distortion loss function. It achieves better performance than H.264. Rippel et al. propose an advanced neural network-based video compression scheme. It inherits and extends traditional video coding schemes with neural networks with the following major features: 1) using only one auto-encoder to compress motion information and residues; 2) motion compensation with multiple frames and multiple optical flows; 3) an on-line state is learned and propagated through the following frames over time. This scheme achieves better performance in MS-SSIM than HEVC reference software.

J. Lin et al. propose an extended end-to-end neural network-based video compression framework based on an existing design. In this solution, multiple frames are used as references. It is thereby able to provide more accurate prediction of current frame by using multiple reference frames and associated motion information. In addition, motion field prediction is deployed to remove motion redundancy along temporal channel. Postprocessing networks are also introduced in this work to remove reconstruction artifacts from previous processes. The performance is better than H.265 by a noticeable margin in terms of both PSNR and MS-SSIM.

Eirikur et al. propose scale-space flow to replace commonly used optical flow by adding a scale parameter based on framework of an existing design. It is reportedly achieving better performance than H.264.

Z. Hu et al. propose a multi-resolution representation for optical flows based on an existing design. Concretely, the motion estimation network produces multiple optical flows with different resolutions and let the network to learn which one to choose under the loss function. The performance is slightly improved and better than H.265.

### 2.4.2. Random Access

Wu et al. propose a neural network-based video compression scheme with frame interpolation. The key frames are first compressed with a neural image compressor and the remaining frames are compressed in a hierarchical order. They perform motion compensation in the perceptual domain, i.e. deriving the feature maps at multiple spatial scales of the original frame and using motion to warp the feature maps, which will be used for the image compressor. The method is reportedly on par with H.264.

Djelouah et al. propose a method for interpolation-based video compression, wherein the interpolation model combines motion information compression and image synthesis, and the same auto-encoder is used for image and residual.

Amirhossein et al. propose a neural network-based video compression method based on variational auto-encoders with a deterministic encoder. Concretely, the model consists of an auto-encoder and an auto-regressive prior. Different from previous methods, this method accepts a group of pictures (GOP) as inputs and incorporates a 3D autoregressive prior by taking into account of the temporal correlation while coding the laten representations. It provides comparative performance as H.265.

### 2.5. Preliminaries

Almost all the natural image/video is in digital format. A grayscale digital image can be represented by x∈ [symbol] , where [symbol] is the set of values of a pixel, m is the image height and n is the image width. For example, [symbol] ={0, 1, 2, . . . , 255} is a common setting and in this case | [symbol] |=256=2⁸, thus the pixel can be represented by an 8-bit integer. An uncompressed grayscale digital image has 8 bits-per-pixel (bpp), while compressed bits are definitely less.

A color image is typically represented in multiple channels to record the color information. For example, in the RGB color space an image can be denoted by x∈ [symbol] with three separate channels storing Red, Green and Blue information. Similar to the 8-bit grayscale image, an uncompressed 8-bit RGB image has 24 bpp. Digital images/videos can be represented in different color spaces. The neural network-based video compression schemes are mostly developed in RGB color space while the traditional codecs typically use YUV color space to represent the video sequences. In YUV color space, an image is decomposed into three channels, namely Y, Cb and Cr, where Y is the luminance component and Cb/Cr are the chroma components. The benefits come from that Cb and Cr are typically down sampled to achieve pre-compression since human vision system is less sensitive to chroma components.

A color video sequence is composed of multiple color images, called frames, to record scenes at different timestamps. For example, in the RGB color space, a color video can be denoted by X={x₀, x₁, . . . , xₜ, . . . , x_{T-1}} where T is the number of frames in this video sequence, x∈ [symbol] . If m=1080, n=1920, | [symbol] |=28, and the video has 50 frames-per-second (fps), then the data rate of this uncompressed video is 1920×1080×8×3×50=2,488,320,000 bits-per-second (bps), about 2.32 Gbps, which needs a lot storage thereby definitely needs to be compressed before transmission over the internet.

Usually the lossless methods can achieve compression ratio of about 1.5 to 3 for natural images, which is clearly below requirement. Therefore, lossy compression is developed to achieve further compression ratio, but at the cost of incurred distortion. The distortion can be measured by calculating the average squared difference between the original image and the reconstructed image, i.e., mean-squared-error (MSE). For a grayscale image, MSE can be calculated with the following equation.

$$M S E = \frac{{‖ x - \hat{x} ‖}^{2}}{m \times n} \qquad ( 4 )$$

Accordingly, the quality of the reconstructed image compared with the original image can be measured by peak signal-to-noise ratio (PSNR):

$$PSNR = 10 \times {log}_{10} \frac{{( max ( 𝔻 ) )}^{2}}{M S E} \qquad ( 5 )$$

where max( [symbol] ) is the maximal value in [symbol] , e.g., 255 for 8-bit grayscale images. There are other quality evaluation metrics such as structural similarity (SSIM) and multi-scale SSIM (MS-SSIM).

To compare different lossless compression schemes, it is sufficient to compare either the compression ratio given the resulting rate or vice versa. However, to compare different lossy compression methods, it has to take into account both the rate and reconstructed quality. For example, to calculate the relative rates at several different quality levels, and then to average the rates, is a commonly adopted method; the average relative rate is known as Bjontegaard's delta-rate (BD-rate). There are other important aspects to evaluate image/video coding schemes, including encoding/decoding complexity, scalability, robustness, and so on.

### 3. Problems

### 3.1. The Core Problem

The state-of-the-art image compression networks include a prediction module (for example an autoregressive neural network) to improve the compression performance. The autoregressive neural network utilizes already processed samples to obtain a next sample, hence the name autoregressive (it predicts future values based on past values). On the other hand, the samples belonging to one part of the latent representation might have very different statistical properties than the other parts. In such a case the performance of the autoregressive model deteriorates.

### 3.2. Details of the Problem

In FIG. 11, an example processing kernel is depicted that can be used to process the latent samples ŷ. The processing kernel is part of the auto-regressive processing module (sometimes called the context module). In the example the context module utilizes 12 samples around the current ŷ[:,i,j], to generate the sample ŷ[:,i,j]. Those samples are depicted in FIG. 11 with empty circles. The sample ŷ[:,i,j] is depicted with filled circle.

As one can understand from FIG. 11, the processing of sample ŷ[:,i,j] requires that the samples ŷ[:,i−1,j], ŷ[:,i,j−1], ŷ[:,i−1,j−1], ŷ[:,i−2,], ŷ[:,i−1,j−1], ŷ[:,i,j−2], ŷ[:,i−1,j−2], ŷ[:,i−2,j−2], ŷ[:,i+1, j−1], ŷ[:,i+1,j−1], ŷ[:,i+1,j−2], ŷ[:,i+2,j−2], (i.e. the 12 samples from the top- left two rows/columns) to be available and already constructed. This poses a strict processing order for the quantized latent.

The processing of a sample requires usage of its neighbor samples at the above and left direction.

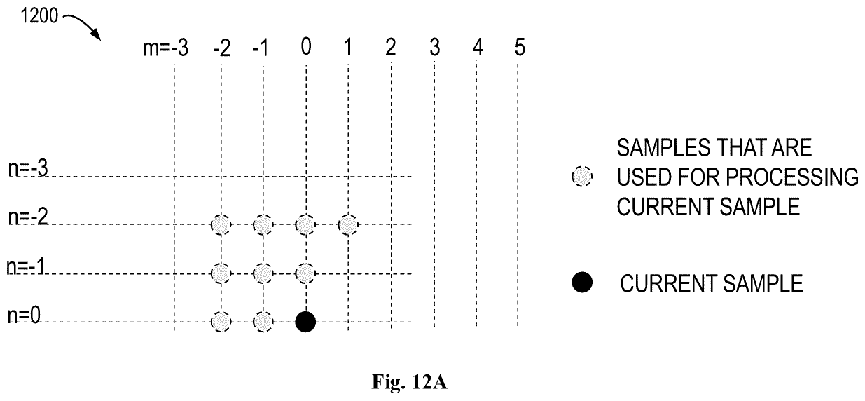

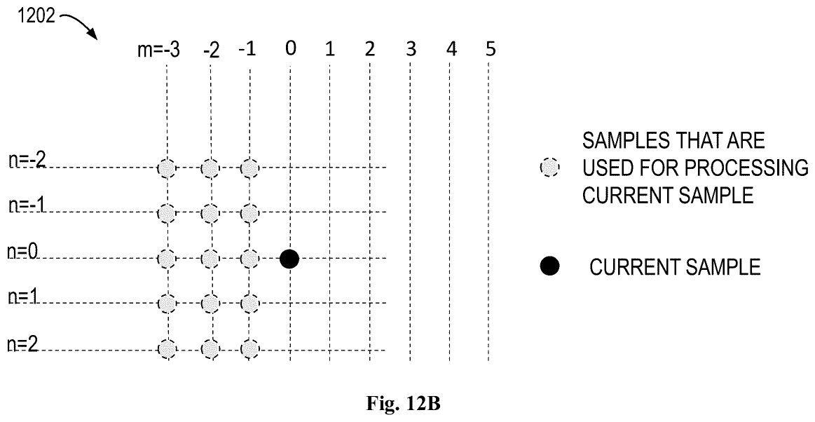

The kernel of the context model can have other shapes. The two other examples are depicted in FIG. 12A and FIG. 12B.

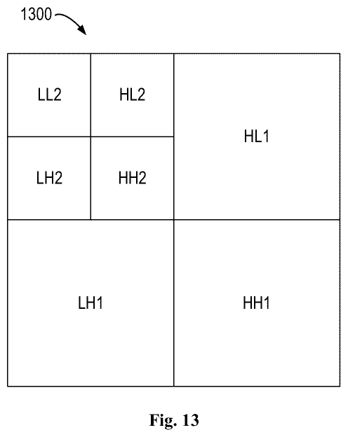

When, however, the latent representation comprises samples that have different statistical properties, the efficiency of the autoregressive model deteriorates. Ones such example is depicted in FIG. 13, wherein the latent representation comprises 7 different regions with different statistical properties. Each region comprises samples that have different frequency components, and hence a sample belonging to region HL1 have very different statistical properties than a sample belonging to region HH1. It is inefficient to predict a sample belonging to region HH1 using samples belonging to HL1.

The problem happens when one of the autoregressive network kernels are applied on the latent samples depicted in FIG. 13. Processing of a current sample requires neighbor samples, and when the current sample is comprised in one region and the neighbor sample belongs to another region, the efficiency of prediction deteriorates. The reason is that, since the statistical properties of samples in different regions are different, using one sample in the processing (e.g. prediction) of another sample in a different region is inefficient.

### 4. Detailed Solutions

The detailed solutions below should be considered as examples to explain general concepts. These solutions should not be interpreted in a narrow way. Furthermore, these solutions can be combined in any manner.

### 4.1. Target of the Solution

The target of the solution is to increase the efficiency of the auto-regressive module by restricting prediction across the boundaries of predetermined regions.

### 4.2. Core of the Solution

The core of the solution governs the processing of latent samples by an autoregressive neural network using a region map.

### 4.3. Details of the Solution

### 4.3.1. Decoding Process

According to the solution the decoding of the bitstream to obtain the reconstructed picture is performed as follows.

An image decoding method known as “isolated coding”, comprising the steps of:
Obtaining, using a neural network, a current latent sample ŷ[i,j] which may be quantized using a neighbour quantized latent sample ŷ[i+m,j+n] if ŷ[i+m,j+n] is in the same region as the current sample;
Obtaining, using a neural network, the current latent sample which may be quantized without using ŷ[i+m,j+n] if ŷ[i+m,j+n] is not in the same region as the current sample;
wherein all indices (i, j, m, n) are integers;

Obtaining the reconstructed image using the quantized latent y and a synthesis transform network.

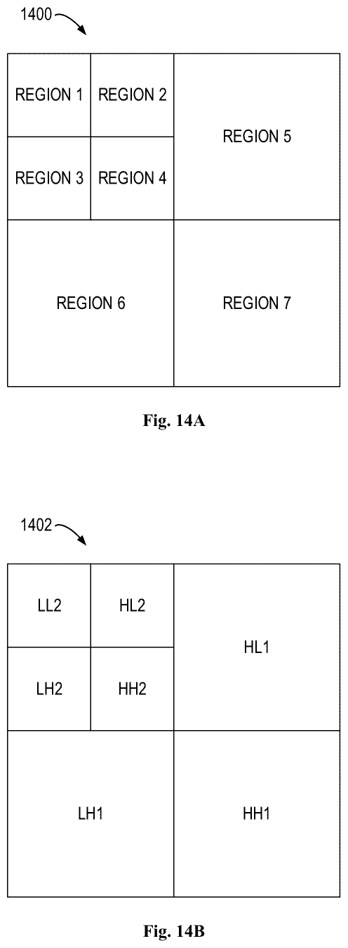

In the decoding process firstly the quantized latent representation is obtained by obtaining its samples (the quantized latent samples). The quantized latent representation might be a tensor or a matrix comprising the quantized latent samples. After the quantized latent samples are obtained, a synthesis transform is applied to obtain the reconstructed image. For obtaining of the quantized latent samples a region map is utilized. The region map is used to divide the quantized latent samples into regions (which could also be called tiles). The possible division of the latent representation are exemplified in FIG. 14A and FIG. 14B.

According to the first example shown in FIG. 14A, the latent representation is divided into 7 regions. In this example the region map comprises 3 large rectangle regions and 4 smaller rectangle regions. The smaller 4 rectangle regions correspond to the top-left corner of the latent representation. This example is selected specifically to correspond to the example on FIG. 10 (which is presented in FIG. 14B again). In FIG. 10 the latent samples are divided into 7 sections as a result of wavelet-based transformation. It was explained above that the statistical properties of the samples corresponding to each section are quite different, therefore of a sample in one region using a sample from another section would not be efficient. According to the solution the latent representation is divided into regions that are aligned with the sections generated by the wavelet-based transform.

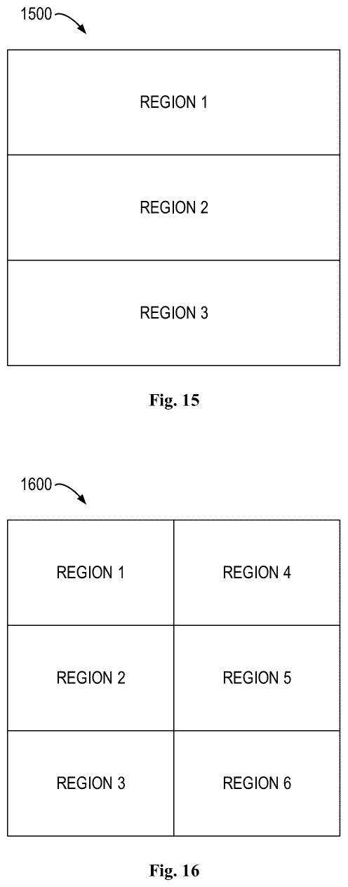

Another example of a region map according to the solution is depicted in FIG. 15. In FIG. 15, the latent representation is divided into 3 regions. According to the solution, a sample belonging to region 1 is processed only using the samples from region 1. A sample belonging to region 2 is processed using only the samples from region 2 etc. A side benefit of the solution is that the processing of region 1, region 2, and region 3 can be performed in parallel. This is because the processing of samples comprised in region one does not depend on the availability of any samples from region 2 or 3. Similarly, samples of region 2 can also be processed independently of other regions. As a result, the three regions can be processed in parallel, which would in turn speed the processing speed. In other cases, to utilize the information between different regions, the encoding and decoding produce can be in some sequence ways, former decoded regions can be used as the reference of the current region that to be coded. Another example region map is depicted in FIG. 16.

If the neighbour quantized latent sample ŷ[i+m,j+n] and the current quantized latent sample ŷ[i,j] is in the same region is determined based on a region map. As exemplified in the examples above, a current sample ŷ[i,j] in region 2 is obtained using the neighboring sample ŷ[i+m,j+n] if the neighbour sample is also in region 2. Otherwise, the current sample ŷ[i,j] is obtained without using ŷ[i+m,j+n].

According to the solution, the region map can be predetermined. Or it can be determined based on an indication in the bitstream. The indication might indicate:
1. Number of regions in the region map that divides the latent representation.
2. Size of a region.
3. Position of a region.

The region map might be obtained according to the size of the latent representation. For example, if the width and height of a latent representation are W and H respectively, and if the latent representation is divided into 3 equal sized regions, the width and height of the regions might be W and H/3 respectively.

The region map might be obtained based on the size of the reconstructed image. For example, if the width and height of the reconstructed image are W and H respectively, and if the latent representation is divided into 3 equal sized regions, the width and height of the regions might be W/K and H/(3K) respectively, wherein K is a predetermined positive integer.

The region map might be obtained according to a depth value, indicating the depth of a synthesis transform. For example, in FIG. 14B the depth of the wavelet-based transform is 2. In such an example the region map might be obtained by first dividing the latent representation into 4 primary rectangles (depth 1) and one of the resulting rectangles are divided into 4 secondary rectangles (corresponding to depth 2). Therefore, the total of 7 regions are obtained according to the depth of the transform that is used (e.g. the wavelet-based transform here).

According to the solution the current quantized latent sample is obtained based on at least one padded sample if ŷ[i+m,j+n] is not in the same region as the current sample. FIG. 12A and FIG. 12B exemplify 2 processing kernels, that might be used to process a current sample. According to the kernels, processing of a current sample might require samples from the left and/or above of the current sample. When those samples are comprised in a different region than the current sample, padded sample values are used to replace those samples that belong to a different region. The padding value might be a constant value such as 0 or 0.5 or some other reasonable constant value, also, the padding value could be the reflection of the current region.

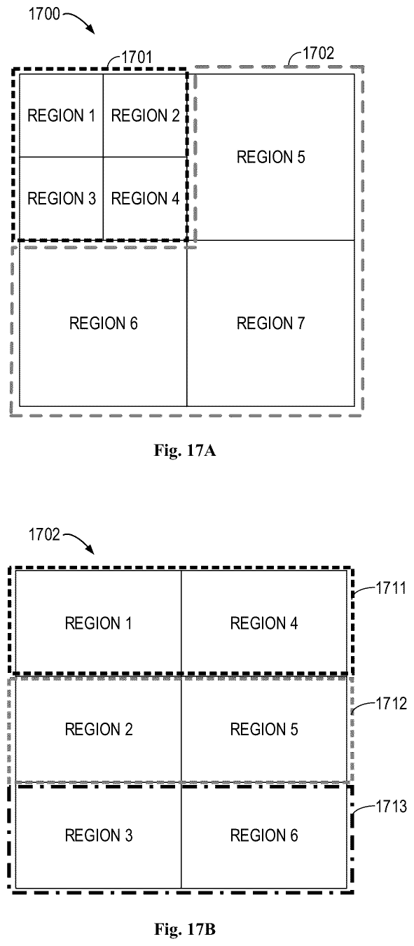

According to the solution, the processing of the current sample might be performed by an auto-regressive neural network or subnetwork. The autoregressive network might be the one explained in section 2.3.6. To utilize the relationship between different regions, the encoding/decoding of different regions can in a different order, and the sample from the coded region can be the reference in the probability modeling of the current region to be coded. In this way, different regions may be divided into different groups. Regions in Different groups may be coded in a different order. For region that inside the same group, parallel encoding and decoding may be used to speed up the coding performance. For region in different group, the former coded region can be used as the reference information to improve the coding performance in current region that to be coded. FIG. 17A and FIG. 17B give two examples of the group division.

In FIG. 17A and FIG. 17B, different groups are marked with dotted lines in different colors or forms. For the splitting example in FIG. 17A, regions are divided into two groups. For region in the same group, it will be encoded and decoded in a parallel way. As for the region in different group, it can be encoded and decoded in a sequential way. For example, in this case, the regions in the group 1701 may be compressed firstly. Then the regions in the group 1701 can be used as the reference when compressing the regions in group 1702. It is needed to say that the compressed order of the group can be designed in other way, it is also possible to compress group 1702 and then compress group 1701 by using information of the group 1702 as the reference. In FIG. 17B, it gives an example of three different groups. In this case, two coded group information can be used as the reference of the third group. In one example, both two coded groups can be used as the reference information. In the other example, only the most relevant group is utilized as the reference.

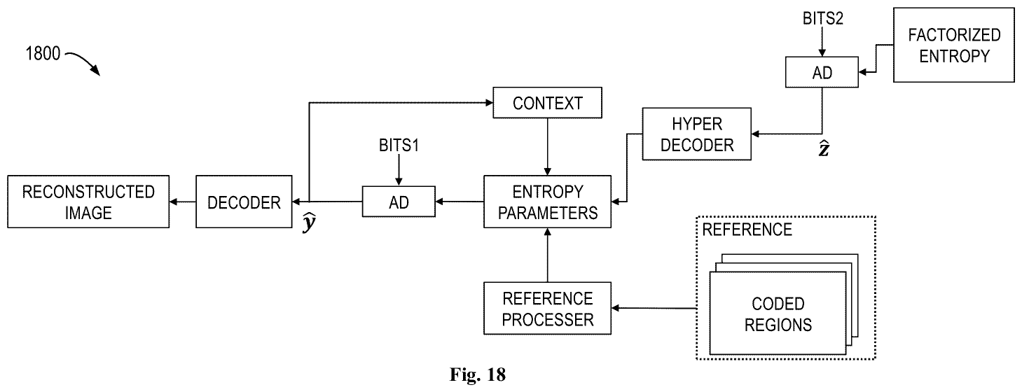

According to the solution, the probability modeling in entropy coding part can utilize coded group information. Example of the probability modeling is shown in the FIG. 18.

According to the example of FIG. 18, the reference information can be processed by ref processer network, and then used for the probability modeling of the entropy parameters.

In one example, the ref processer may be composed by convolutional networks.

In one example, the ref processer is using pixel cnn.

In one example, the ref processer may be some down sampling or up sampling method.

In one example, the ref processer can be removed, and the reference information is directly fed into the entropy parameters.

Alternatively, the reference information also can be fed into the hyper decoder.

According to the solution, the synthesis transform or the analysis transform can be wavelet-based transforms.

In one example, the isolated coding method may be applied to a first set latent samples (which may be quantized), and/or it may not be applied to a second latent samples (which may be quantized).

In one example, the isolated coding method may be applied to samples (which may be quantized) in a first region, and/or it may not be applied to latent samples (which may be quantized) in a second region.

In one example, the region locations and/or dimensions may be determined depending on color format/color components.

In one example, the region locations and/or dimensions may be determined depending on whether the picture is resized.

In one example, whether and/or how to apply the isolated coding method may depend on the latent sample location.

In one example, whether and/or how to apply the isolated coding method may depend on whether the picture is resized.

In one example, whether and/or how to apply the isolated coding method may depend on color format/color components.

### 4.3.2. Encoding Process

According to the solution, the encoding process follows the same process as the decoding process for obtaining the quantized latent samples. The difference is that, after the quantizes latent samples are obtained, the samples are included in a bitstream using an entropy encoding method.

According to the solution, the encoding of an input image to obtain bitstream is performed as follows. An image encoding method, comprising the steps of:
Obtaining, using a neural network, the current quantized latent sample using a quantized latent sample ŷ[i+m,j+n] if ŷ[i+m,j+n] is in the same region as the current sample ŷ[i,j];
Obtaining, using a neural network, the current quantized latent sample without using ŷ[i+m,j+n] if ŷ[i+m,j+n] is not in the same region as the current sample;
wherein all indices (i, j, m, n) are integers;
Obtaining a bitstream using the quantized latent y and an entropy encoding module.

### 4.4. Benefit of the Solution

The solution provides a method of improving the efficiency of obtaining quantized latent samples when the latent representation is composed of regions with different statistical properties. Additionally, it allows processing of different regions in parallel, as the samples of each region are processed independently of each other. Moreover, to further improve the coding efficiency, some regions can be coded in a sequential way, which means the former coded region can be used to boost the compression ration of the current region to be coded.

### 5. Embodiments

1. An Image Decoding Method, Comprising the Steps of:
Obtaining, using a neural network, a current quantized latent sample ŷ[i,j] using a neighbour quantized latent sample ŷ[i+m,j+n], if ŷ[i+m,j+n] is in the same region as the current sample,
Obtaining, using a neural network, the current quantized latent sample without using ŷ[i+m,j+n], if ŷ[i+m,j+n] is not in the same region as the current sample,
Obtaining the reconstructed image using the quantized latent ŷ and a synthesis transform network, wherein
all indices (i, j, m, n) are integers.

2. An image encoding method, comprising the steps of:
Obtaining a latent sample using an analysis transform,
Obtaining the quantized latent ŷ by using the steps below;
Obtaining, using a neural network, the current quantized latent sample using a quantized latent sample ŷ[i+m,j+n] if ŷ[i+m,j+n] is in the same region as the current sample ŷ[i,j],
Obtaining, using a neural network, the current quantized latent sample without using ŷ[i+m,j+n] if ŷ[i+m,j+n] is not in the same region as the current sample.
Obtaining a bitstream using the quantized latent y and an entropy encoding module, wherein all indices (i, j, m, n) are integers.

3. According to embodiment 1 or 2,
Determination of if the neighbour quantized latent sample ŷ[i+m,j+n] and the current quantized latent sample ŷ[i,j] is in the same region is performed based on a region map.

4. According to embodiment 3,
The region map is predetermined.

5. According to embodiment 3 or 4,
The region map is obtained according to an indication in the bitstream.

6. According to embodiment 3, 4 or 5,
The region map is obtained according to the width and height of the quantized latent representation, which is a matrix or tensor that comprises quantized latent samples.

7. According to all embodiments above,
The region map is obtained according to the width and height of the said reconstructed image.

8. According to all embodiments above,
The region map is obtained according to a depth value, indicating the depth of the synthesis transform.

9. According to all embodiments above,
The region map is obtained by first dividing the quantized latent representation into 4 primary rectangular regions, and dividing the first primary rectangular region further into 4 secondary rectangular regions.

10. According to embodiment 9,
The first primary rectangular region is the top-left primary rectangular region.

11. According to embodiment 9 or 10,
Not dividing the remaining 3 primary rectangular regions into secondary regions.

12. According to all embodiments above,
The region map is obtained according to a depth value of a transform.

13. According to all embodiments above,
Obtaining, using a neural network, the current quantized latent sample based on at least one padded sample if ŷ[i+m,j+n] is not in the same region as the current sample.

14. According to all embodiment 13,
The said padded sample has a predetermined value.

15. According to embodiment 14,
The predetermined value is a constant value.

16. According to embodiment 15,
The predetermined value is equal to 0.

17. According to all embodiments above,
The said neural network is an auto-regressive neural network.

18. According to all embodiments above,
The synthesis transform or the analysis transform is wavelet-based transforms.

More details of the embodiments of the present disclosure will be described below which are related to neural network-based visual data coding. As used herein, the term “visual data” may refer to an image, a picture in a video, or any other visual data suitable to be coded.

As discussed above, in the existing design, a prediction module (e.g., an autoregressive model) is employed to improve the compression performance. The autoregressive model utilizes already processed samples to obtain a next sample, hence the coding efficiency is limited by this autoregressive process. On the other hand, samples in one region of the latent representation might have very different statistical properties than the other region(s). In such a case, the coding quality of the autoregressive model deteriorates.

To solve the above problems and some other problems not mentioned, visual data processing solutions as described below are disclosed. The embodiments of the present disclosure should be considered as examples to explain the general concepts and should not be interpreted in a narrow way. Furthermore, these embodiments can be applied individually or combined in any manner.

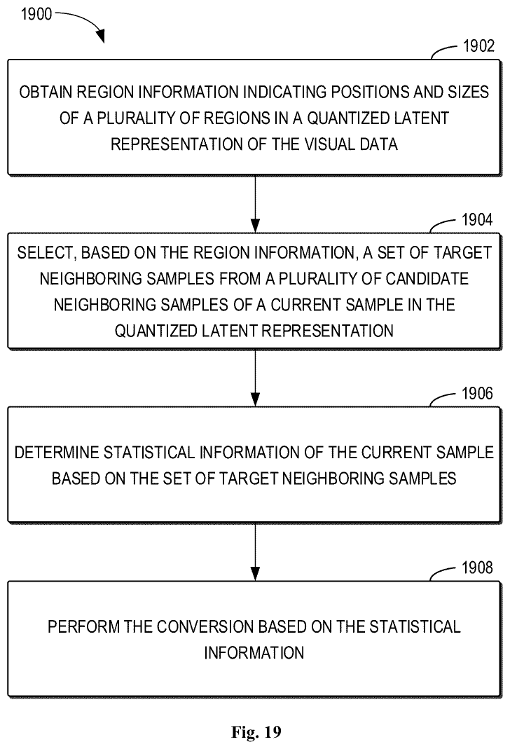

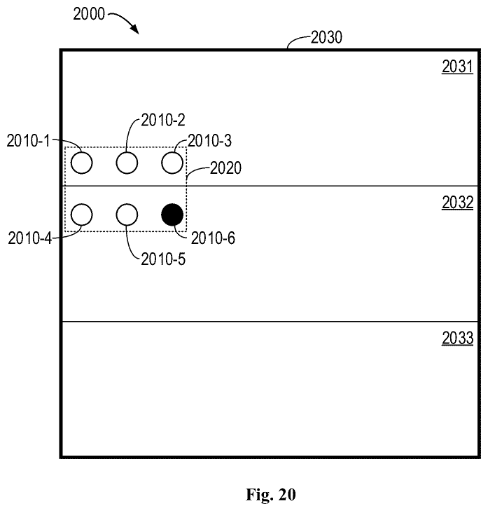

FIG. 19 illustrates a flowchart of a method 1900 for visual data processing in accordance with some embodiments of the present disclosure. The method 1900 may be implemented during a conversion between the visual data and a bitstream of the visual data. As shown in FIG. 19, the method 1900 starts at 1902, region information is obtained. The region information (also referred to as a region map herein) indicates positions and sizes of a plurality of regions in a quantized latent representation of the visual data. For purpose of illustration rather than limitation, FIG. 20 illustrates an example of visual data processing in accordance with some embodiments of the present disclosure. As shown in FIG. 20, the quantized latent representation 2030 of the visual data is divided into three regions, i.e., region 2031, region 2032 and region 2033.

In some embodiment, the region information may be determined at the encoder side and the decoder side, separately. Alternatively, the region information indication may be determined at the encoder side and indicated in the bitstream, e.g., by an appropriate indication. Then, the decoder may obtain the region information from the bitstream. Additionally or alternatively, the region information may be predetermined. The determination of the region information will be described in detail below.

Turning back to FIG. 19, at 1904, based on the region information, a set of target neighboring samples is selected from a plurality of candidate neighboring samples of a current sample in the quantized latent representation. The set of target neighboring samples is in the same region as the current sample. In some embodiments, the plurality of candidate neighboring samples may be dependent on a processing kernel used to processing the current sample.

With reference to FIG. 20, the current sample 2010-6 is processed based on a processing kernel 2020. In such a case, the plurality of candidate neighboring samples for processing the current sample 2010-6 comprises samples 2010-1, 2010-2, 2010-3, 2010-4, and 2010-5 neighboring to the current sample 2010-6. It is seen that the samples 2010-4, 2010-5 and the current 2010-6 are located in the region 2032, while the samples 2010-1, 2010-2 and 2010-3 are located in the region 2031. In such a case, the samples 2010-4 and 2010-5 are selected from the plurality of candidate neighboring samples.

Turning back to FIG. 19, at 1906, statistical information of the current sample is determined based on the set of target neighboring samples. By way of example rather than limitation, the statistical information may comprise a mean value, a variance, and/or the like. In some embodiments, the statistical information of the current sample may be determined by using the set of target neighboring samples without considering the rest of the plurality of candidate neighboring samples. Alternatively, the rest of the plurality of candidate neighboring samples may be padded, and the statistical information of the current sample may be determined by using the set of target neighboring samples and the padded samples, which will be described in detail below. Thereby, the processing of samples in different regions may be decoupled. In other words, samples in different regions are allowed to be processed in parallel, which will improve the coding efficiency.

At 1908, the conversion is performed based on the statistical information. In some embodiments, the conversion may include encoding the visual data into the bitstream. Additionally or alternatively, the conversion may include decoding the visual data from the bitstream.

By way of example rather than limitation, with reference to FIGS. 6 and 7, the statistical information may be generated by the entropy parameters module, which may be a neural network and a part of the autoregressive model. At the encoder side, a sample of the quantized latent representation y may be encoded into the bitstream by an arithmetic encoding module (denoted as AE in FIG. 6) based on the corresponding statistical information, as shown in FIG. 6. At the decoder side, a sample of the quantized latent representation y may be decoded from the bitstream by an arithmetic decoding module (denoted as AD in FIG. 7) based on the corresponding statistical information, as shown in FIG. 7. Then, a synthesis transform may be performed on the quantized latent representation y, so as to reconstruct the visual image.

In view of the foregoing, the statistical information of a current sample in the quantized latent representation of the visual data is determined based on a set of neighboring samples in the same region as the current sample. In aid of taking the region information regarding a plurality of regions in the quantized latent representation into consideration, the proposed method can advantageously improve the coding quality, especially in a case that the latent representation of the visual data comprises regions with different statistical properties.

In some embodiments, a latent representation of the visual data may be generated by performing a transform on the visual data. In one example, the transform may be an analysis transform. The analysis transform may be performed by using a neural network, as shown in FIG. 4. In another example, the transform may be a wavelet-based forward transform, as described above with reference to FIGS. 8-9. Alternatively, the transform may be a discrete cosine transform (DCT). It should be understood that the above examples are described merely for purpose of description. The scope of the present disclosure is not limited in this respect.

In some embodiments, the quantized latent representation of the visual data may be generated by quantizing at least a part of the latent representation of the visual data. In one example, the quantized latent representation is generated by applying a quantization process on the latent representation the visual data, e.g., at the encoder side. In another example, each sample in the latent representation the visual data may be divided into two components, e.g., a prediction and a residual. The prediction of a sample may be predicted based on information coded in the bitstream, while the residual of the sample may be quantized and coded in the bitstream. In such a case, the latent representation may be reconstructed based on the prediction and quantized residual of each sample. It should be noted that the reconstructed latent representation may also be referred to as a quantized latent representation in a sense that the residual is quantized.

In view of the fact that a size of the quantized latent representation is the same as the latent representation, the region information may also be regard as indicating positions and sizes of a plurality of regions in a latent representation of the visual data. The scope of the present disclosure is not limited in this respect.

In some embodiments, the region information may be determined based on a depth of the transform, the number of regions in the plurality of regions, the sizes of the plurality of regions, the positions of the plurality of regions, a size (such as a height or a width) of the latent representation, a size of the quantized latent representation, a size of a reconstruction of the visual data (i.e., the reconstructed visual data), a color format of the visual data, a color component of the visual data, information regarding whether the visual data may be resized, and/or the like.

For example, a region corresponding to the quantized latent representation may be set as a reference region. The following operations may be performed iteratively: dividing the reference region into a plurality of sub-regions; and selecting one of the plurality of sub-regions as the reference region. By way of example rather than limitation, the number of iterations of the operations may be equal to the depth of the transform. The number of sub-regions in the plurality of sub-regions may be 4 or any other suitable integer. Furthermore, the selected one may be a top-left sub-region in the plurality of sub-regions. In a case that the depth of the transform is 2, an exemplary result of the above iterative operations is shown in FIG. 14A. As shown in FIG. 14A, the quantized latent representation comprises three primary regions (i.e., region 5, region 6 and region 7) and four secondary regions (i.e., region 1, region 2, region 3 and region 4). Thereby, the partition of the regions may better suit the distribution of statistical properties in the latent representation, and thus the coding quality can be further improved.

For example, in a case that the width and height of a quantized latent representation are W and H respectively, and the quantized latent representation is divided into three equal sized regions, the width and height of each of the three regions may be W and H/3, respectively. Alternatively, the width and height of each of the three regions may be W/3 and H, respectively.

For example, in a case that the width and height of the reconstructed visual data are WI and HE respectively, and the quantized latent representation is divided into five equal sized regions, the width and height of each of the three regions may be WI/K and HE/(5K), respectively, where K is a scaling factor between the reconstructed visual data and the quantized latent representation. Alternatively, the width and height of each of the three regions may be WI/(5K) and HE/K, respectively.

It should be understood that the above illustrations and/or examples are described merely for purpose of description. The scope of the present disclosure is not limited in this respect.

In some embodiments, at 1906, values for a part of samples in the processing kernel may be determined based on values for the set of target neighboring samples. Values for the rest of the samples in the processing kernel may be determined based on values for samples in a current region in which the current sample may be located or a predetermined value. Furthermore, the statistical information of the current sample may be determined based on values for the samples in the processing kernel. By way of example, with reference to FIG. 20, values for samples 2010-4 and 2010-5 of the processing kernel 2020 may be set equal to values of the corresponding samples in the quantized latent representation 2030. Moreover, values for samples 2010-1, 2010-2 and 2010-3 may be set equal to a predetermined value (e.g., a constant value, such as 0 or 0.5). Alternatively, values for samples 2010-1, 2010-2 and 2010-3 may be padded by mirroring the current region 2032. For example, the value for the sample 2010-1 may be set equal to the value for the sample 2010-4, the value for the sample 2010-2 may be set equal to the value for the sample 2010-5, and the value for the sample 2010-3 may be set equal to a predetermined value (e.g., a constant value, such as 0 or 0.5). It should be understood that the above illustrations and/or examples are described merely for purpose of description. The scope of the present disclosure is not limited in this respect.

In some embodiments, at 1906, the statistical information of the current sample may be generated based on the set of target neighboring samples and at least one target region of the plurality of regions. The at least one target region may be coded before a current region in which the current sample may be located. By way of example, with reference to FIG. 20, region 2031 may be coded before the current region 2032, and then be used for coding the current sample 2010-6. Thereby, the coding quality may be further improved.

In some embodiments, reference information may be generated based on the at least one target region. Furthermore, the statistical information of the current sample may be generated based on the set of target neighboring samples and the reference information. By way of example rather than limitation, with reference to FIG. 18, the reference information may be generated by a reference processor based on the at least one target region (denoted as reference/coded regions in FIG. 18). The reference processor may comprise a convolution network, a pixel convolutional neural network, a down-sampling process, an up-sampling process, and/or the like. Additionally or alternatively, the reference information may be fed into the hyper decoder module.

In some embodiments, the plurality of regions may be grouped into a plurality of groups of regions. By way of example rather than limitation, with reference to FIG. 17B, the plurality of regions may be grouped into three groups. The first group comprises region 1 and region 4. The second group comprises region 2 and region 5. The third group comprises region 3 and region 6.

In some embodiments, a first sample in a first region and the current sample may be processed in parallel, i.e., at the same time. The first region is different from a current region in which the current sample is located. Moreover, the first region and the current region are comprised in a current group of regions among the plurality of groups of regions. That is, the first region and the current region are comprised in the sample group. By way of example rather than limitation, with reference to FIG. 17B, samples in region 1 and region 4 may be processed at the same time, samples in region 2 and region 5 may be processed in parallel, and samples in region 3 and region 6 may be processed in parallel.

In some embodiments, all samples in a second region may be processed before or after all samples in the current region. The second region is different from the current region, and the second region is comprised in a further group of regions different from the current group of regions. In other words, the second region and the current region are comprised in different groups. By way of example rather than limitation, with reference to FIG. 17B, samples in region 1 and region 4 may be processed before samples in region 2 and region 5, and samples in region 2 and region 5 may be processed before samples in region 3 and region 6. In other words, the different groups of regions are processed in a sequential way. Additionally, the previously coded regions may be used as reference information for coding, as described above.

In some embodiments, each of the at least one target region may be in a group of regions different from the current group of regions. That is, only coded regions from a different group may be used as reference information for coding.

In some embodiments, the quantized latent representation may comprise a further sample different from the current sample, and statistical information of the further sample may be determined without using the region information. In other words, part of the quantized latent representation may be coded based on a conventional solution. In some embodiments, the further sample may be in a region different from the current sample.

In some embodiments, information regarding whether to apply the method disclosed herein may be dependent on a position of the current sample, information regarding whether the visual data may be resized, a color format of the visual data, a color component of the visual data, and/or the like. Additionally or alternatively, information regarding how to apply the method disclosed herein may be dependent on a position of the current sample, information regarding whether the visual data may be resized, a color format of the visual data, a color component of the visual data, and/or the like.

According to further embodiments of the present disclosure, a non-transitory computer-readable recording medium is provided. The non-transitory computer-readable recording medium stores a bitstream of visual data which is generated by a method performed by an apparatus for visual data processing. In the method, region information is obtained and indicates positions and sizes of a plurality of regions in a quantized latent representation of the visual data. Based on the region information, a set of target neighboring samples is selected from a plurality of candidate neighboring samples of a current sample in the quantized latent representation. The set of target neighboring samples is in the same region as the current sample. Statistical information of the current sample is determined based on the set of target neighboring samples. Moreover, the bitstream is generated based on the statistical information.

According to still further embodiments of the present disclosure, a method for storing a bitstream of visual data is provided. In the method, region information is obtained and indicates positions and sizes of a plurality of regions in a quantized latent representation of the visual data. Based on the region information, a set of target neighboring samples is selected from a plurality of candidate neighboring samples of a current sample in the quantized latent representation. The set of target neighboring samples is in the same region as the current sample. Statistical information of the current sample is determined based on the set of target neighboring samples. Moreover, the bitstream is generated based on the statistical information and stored in a non-transitory computer-readable recording medium.

Implementations of the present disclosure can be described in view of the following clauses, the features of which can be combined in any reasonable manner.

Clause 1. A method for visual data processing, comprising: obtaining, for a conversion between visual data and a bitstream of the visual data, region information indicating positions and sizes of a plurality of regions in a quantized latent representation of the visual data; selecting, based on the region information, a set of target neighboring samples from a plurality of candidate neighboring samples of a current sample in the quantized latent representation, the set of target neighboring samples being in the same region as the current sample; determining statistical information of the current sample based on the set of target neighboring samples; and performing the conversion based on the statistical information.

Clause 2. The method of clause 1, wherein the region information is indicated in the bitstream, and obtaining the region information comprises: obtaining the region information from the bitstream.

Clause 3. The method of any of clauses 1-2, wherein the quantized latent representation of the visual data is generated by quantizing at least a part of a latent representation of the visual data, and the latent representation of the visual data is generated by performing a transform on the visual data.

Clause 4. The method of any of clauses 1-3, wherein the region information is determined based on at least one of the following: a depth of the transform, the number of regions in the plurality of regions, the sizes of the plurality of regions, the positions of the plurality of regions, a size of the latent representation, a size of the quantized latent representation, a size of a reconstruction of the visual data, a color format of the visual data, a color component of the visual data, or information regarding whether the visual data is resized.

Clause 5. The method of any of clauses 3-4, wherein obtaining the region information comprises: setting a region corresponding to the quantized latent representation as a reference region; and perform the following operations iteratively: dividing the reference region into a plurality of sub-regions; and selecting one of the plurality of sub-regions as the reference region.

Clause 6. The method of clause 5, wherein the number of iterations of the operations is equal to the depth of the transform.

Clause 7. The method of any of clauses 5-6, wherein the number of sub-regions in the plurality of sub-regions is 4.

Clause 8. The method of any of clauses 5-7, wherein the selected one is a top-left sub-region in the plurality of sub-regions.

Clause 9. The method of any of clauses 1-8, wherein the region information is predetermined.

Clause 10. The method of any of clauses 1-9, wherein the plurality of candidate neighboring samples are dependent on a processing kernel used to processing the current sample.

Clause 11. The method of clause 10, wherein determining the statistical information of the current sample comprises: determining values for a part of samples in the processing kernel based on values for the set of target neighboring samples; determining values for the rest of the samples in the processing kernel based on one of the following: values for samples in a current region in which the current sample is located, or a predetermined value; and determining the statistical information based on values for the samples in the processing kernel.

Clause 12. The method of clause 11, wherein the predetermined value is constant.

Clause 13. The method of any of clauses 11-12, wherein the predetermined value is 0 or 0.5.

Clause 14. The method of any of clauses 1-13, wherein determining the statistical information of the current sample comprises: generating the statistical information based on the set of target neighboring samples and at least one target region of the plurality of regions, the at least one target region being coded before a current region in which the current sample is located.

Clause 15. The method of clause 14, wherein generating the statistical information of the current sample comprises: generating reference information based on the at least one target region; and generating the statistical information based on the set of target neighboring samples and the reference information.

Clause 16. The method of clause 15, wherein the reference information is generated by applying at least one of the following on the at least one target region: a convolution network, a pixel convolutional neural network, a down-sampling process, or an up-sampling process.

Clause 17. The method of any of clauses 1-16, wherein the plurality of regions are grouped into a plurality of groups of regions, a first sample in a first region and the current sample are processed in parallel, the first region being different from a current region in which the current sample is located, the first region and the current region being comprised in a current group of regions among the plurality of groups of regions.

Clause 18. The method of clause 17, wherein all samples in a second region are processed before or after all samples in the current region, the second region being different from the current region, and the second region being comprised in a further group of regions different from the current group of regions.

Clause 19. The method of any of clauses 17-18, wherein each of the at least one target region is in a group of regions different from the current group of regions.

Clause 20. The method of any of clauses 3-19, wherein the transform comprises one of the following: an analysis transform, a wavelet-based forward transform, or a discrete cosine transform (DCT).

Clause 21. The method of any of clauses 1-20, wherein the transform is performed by using a first neural network.

Clause 22. The method of any of clauses 1-21, wherein the statistical information of the current sample is determined by using a second neural network.

Clause 23. The method of clause 22, wherein the second neural network is auto-regressive.

Clause 24. The method of any of clauses 1-23, wherein the quantized latent representation comprises a further sample different from the current sample, and statistical information of the further sample is determined without using the region information.

Clause 25. The method of clause 24, wherein the further sample is in a region different from the current sample.

Clause 26. The method of any of clauses 1-25, wherein the statistical information comprises at least one of the following: a mean value, or a variance.

Clause 27. The method of any of clause 1-26, wherein information regarding whether to and/or how to apply the method is dependent on at least one of the following: a position of the current sample, information regarding whether the visual data is resized, a color format of the visual data, or a color component of the visual data.

Clause 28. The method of any of clauses 1-27, wherein the visual data comprise a picture of a video or an image.

Clause 29. The method of any of clauses 1-28, wherein the conversion includes encoding the visual data into the bitstream.

Clause 30. The method of any of clauses 1-28, wherein the conversion includes decoding the visual data from the bitstream.

Clause 31. An apparatus for visual data processing comprising a processor and a non-transitory memory with instructions thereon, wherein the instructions upon execution by the processor, cause the processor to perform a method in accordance with any of clauses 1-30.

Clause 32. A non-transitory computer-readable storage medium storing instructions that cause a processor to perform a method in accordance with any of clauses 1-30.

Clause 33. A non-transitory computer-readable recording medium storing a bitstream of visual data which is generated by a method performed by an apparatus for visual data processing, wherein the method comprises: obtaining region information indicating positions and sizes of a plurality of regions in a quantized latent representation of the visual data; selecting, based on the region information, a set of target neighboring samples from a plurality of candidate neighboring samples of a current sample in the quantized latent representation, the set of target neighboring samples being in the same region as the current sample; determining statistical information of the current sample based on the set of target neighboring samples; and generating the bitstream based on the statistical information.

Clause 34. A method for storing a bitstream of visual data, comprising: obtaining region information indicating positions and sizes of a plurality of regions in a quantized latent representation of the visual data; selecting, based on the region information, a set of target neighboring samples from a plurality of candidate neighboring samples of a current sample in the quantized latent representation, the set of target neighboring samples being in the same region as the current sample; determining statistical information of the current sample based on the set of target neighboring samples; generating the bitstream based on the statistical information; and storing the bitstream in a non-transitory computer-readable recording medium.

### Example Device

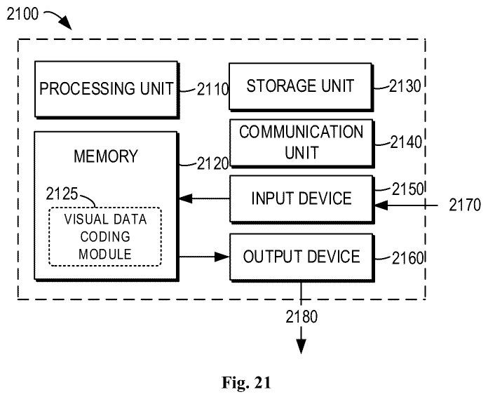

FIG. 21 illustrates a block diagram of a computing device 2100 in which various embodiments of the present disclosure can be implemented. The computing device 2100 may be implemented as or included in the source device 110 (or the visual data encoder 114) or the destination device 120 (or the visual data decoder 124).

It would be appreciated that the computing device 2100 shown in FIG. 21 is merely for purpose of illustration, without suggesting any limitation to the functions and scopes of the embodiments of the present disclosure in any manner.

As shown in FIG. 21, the computing device 2100 includes a general-purpose computing device 2100. The computing device 2100 may at least comprise one or more processors or processing units 2110, a memory 2120, a storage unit 2130, one or more communication units 2140, one or more input devices 2150, and one or more output devices 2160.

In some embodiments, the computing device 2100 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 2100 can support any type of interface to a user (such as “wearable” circuitry and the like).

The processing unit 2110 may be a physical or virtual processor and can implement various processes based on programs stored in the memory 2120. In a multi-processor system, multiple processing units execute computer executable instructions in parallel so as to improve the parallel processing capability of the computing device 2100. The processing unit 2110 may also be referred to as a central processing unit (CPU), a microprocessor, a controller or a microcontroller.

The computing device 2100 typically includes various computer storage medium. Such medium can be any medium accessible by the computing device 2100, including, but not limited to, volatile and non-volatile medium, or detachable and non-detachable medium. The memory 2120 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 2130 may be any detachable or non-detachable medium and may include a machine-readable medium such as a memory, flash memory drive, magnetic disk or another other media, which can be used for storing information and/or visual data and can be accessed in the computing device 2100.

The computing device 2100 may further include additional detachable/non-detachable, volatile/non-volatile memory medium. Although not shown in FIG. 21, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more visual data medium interfaces.

The communication unit 2140 communicates with a further computing device via the communication medium. In addition, the functions of the components in the computing device 2100 can be implemented by a single computing cluster or multiple computing machines that can communicate via communication connections. Therefore, the computing device 2100 can operate in a networked environment using a logical connection with one or more other servers, networked personal computers (PCs) or further general network nodes.

The input device 2150 may be one or more of a variety of input devices, such as a mouse, keyboard, tracking ball, voice-input device, and the like. The output device 2160 may be one or more of a variety of output devices, such as a display, loudspeaker, printer, and the like. By means of the communication unit 2140, the computing device 2100 can further communicate with one or more external devices (not shown) such as the storage devices and display device, with one or more devices enabling the user to interact with the computing device 2100, or any devices (such as a network card, a modem and the like) enabling the computing device 2100 to communicate with one or more other computing devices, if required. Such communication can be performed via input/output (I/O) interfaces (not shown).

In some embodiments, instead of being integrated in a single device, some or all components of the computing device 2100 may also be arranged in cloud computing architecture. In the cloud computing architecture, the components may be provided remotely and work together to implement the functionalities described in the present disclosure. In some embodiments, cloud computing provides computing, software, visual data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding visual data may be stored on a server at a remote position. The computing resources in the cloud computing environment may be merged or distributed at locations in a remote visual data center. Cloud computing infrastructures may provide the services through a shared visual data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 2100 may be used to implement visual data encoding/decoding in embodiments of the present disclosure. The memory 2120 may include one or more visual data coding modules 2125 having one or more program instructions. These modules are accessible and executable by the processing unit 2110 to perform the functionalities of the various embodiments described herein.

In the example embodiments of performing visual data encoding, the input device 2150 may receive visual data as an input 2170 to be encoded. The visual data may be processed, for example, by the visual data coding module 2125, to generate an encoded bitstream. The encoded bitstream may be provided via the output device 2160 as an output 2180.

In the example embodiments of performing visual data decoding, the input device 2150 may receive an encoded bitstream as the input 2170. The encoded bitstream may be processed, for example, by the visual data coding module 2125, to generate decoded visual data. The decoded visual data may be provided via the output device 2160 as the output 2180.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for visual data processing, comprising:
obtaining, for a conversion between visual data and a bitstream of the visual data, region information indicating sizes of a plurality of regions in a quantized latent representation of the visual data;
selecting, based on the region information, a set of target neighboring samples from a plurality of candidate neighboring samples of a current sample in the quantized latent representation, the set of target neighboring samples being in the same region as the current sample;
determining the current sample based on the set of target neighboring samples; and
performing the conversion based on the current sample.

2. The method of claim 1, wherein the current sample is a quantized latent sample of the visual data.

3. The method of claim 1, wherein the determination of the current sample and a determination of a further sample in the quantized latent representation is allowed to be performed in parallel, and the further sample is located in a region different from a region in which the current sample located.

4. The method of claim 1, wherein the current sample is determined by using an auto-regressive process.

5. The method of claim 4, wherein the auto-regressive process is a context model or a multistage context model.

6. The method of claim 1, wherein the region information is determined based on at least one of the following:
a depth of a transform that is performed to obtain a latent representation of the visual data,
the number of regions in the plurality of regions,
the sizes of the plurality of regions,
positions of the plurality of regions,
a size of the latent representation,
a size of the quantized latent representation,
a size of a reconstruction of the visual data,
a color format of the visual data,
a color component of the visual data, or
information regarding whether the visual data is resized.

7. The method of claim 6, wherein the bitstream comprises at least one indication associated with the number of regions in the plurality of regions, or
wherein the bitstream comprises at least one indication associated with the sizes of the plurality of regions.

8. The method of claim 1, wherein determining the current sample comprises:
determining statistical information of the current sample based on the set of target neighboring samples; and
determining the current sample based on the statistical information.

9. The method of claim 8, wherein the plurality of candidate neighboring samples are dependent on a processing kernel used to processing the current sample.

10. The method of claim 9, wherein determining the statistical information of the current sample comprises:
determining values for a part of samples in the processing kernel based on values for the set of target neighboring samples;
determining values for the rest of the samples in the processing kernel based on a predetermined value; and
determining the statistical information based on values for the samples in the processing kernel.

11. The method of claim 10, wherein the predetermined value is constant.

12. The method of claim 10, wherein the predetermined value is 0.

13. The method of claim 6, wherein the transform comprises one of the following:
an analysis transform,
a wavelet-based forward transform, or
a discrete cosine transform (DCT).

14. The method of claim 8, wherein the statistical information comprises at least one of the following:
a mean value, or
a variance.

15. The method of claim 1, wherein the visual data comprise a picture of a video or an image.

16. The method of claim 1, wherein the conversion includes encoding the visual data into the bitstream.

17. The method of claim 1, wherein the conversion includes decoding the visual data from the bitstream.

18. An apparatus for visual data processing comprising a processor and a non-transitory memory with instructions thereon, wherein the instructions upon execution by the processor, cause the processor to perform acts comprising:
obtaining, for a conversion between visual data and a bitstream of the visual data, region information indicating sizes of a plurality of regions in a quantized latent representation of the visual data;
selecting, based on the region information, a set of target neighboring samples from a plurality of candidate neighboring samples of a current sample in the quantized latent representation, the set of target neighboring samples being in the same region as the current sample;
determining the current sample based on the set of target neighboring samples; and
performing the conversion based on the current sample.

19. A non-transitory computer-readable storage medium storing instructions that cause a processor to perform acts comprising:
obtaining, for a conversion between visual data and a bitstream of the visual data, region information indicating sizes of a plurality of regions in a quantized latent representation of the visual data;
selecting, based on the region information, a set of target neighboring samples from a plurality of candidate neighboring samples of a current sample in the quantized latent representation, the set of target neighboring samples being in the same region as the current sample;
determining the current sample based on the set of target neighboring samples; and
performing the conversion based on the current sample.

20. A non-transitory computer-readable recording medium storing a bitstream of visual data which is generated by a method performed by an apparatus for visual data processing, wherein the method comprises:
obtaining region information indicating sizes of a plurality of regions in a quantized latent representation of the visual data;
selecting, based on the region information, a set of target neighboring samples from a plurality of candidate neighboring samples of a current sample in the quantized latent representation, the set of target neighboring samples being in the same region as the current sample;
determining the current sample based on the set of target neighboring samples; and
generating the bitstream based on the current sample.
